(19) United States
(12) Patent Application Publication
(10) Pub. No.: US 2026/0244446 A1
(43) Pub. Date: Aug. 20, 2026

(54) Automatically Enhancing API Documentation Using Self-Play

(71) Applicant: GDM Holding LLC, Mountain View, CA (US)

(72) Inventors: Sandeep Tata, San Francisco, CA (US); Beliz Gunel, San Francisco, CA (US); James Bradley Wendt, San Francisco, CA (US)

(21) Appl. No.: 19/057,522

(22) Filed: Feb. 19, 2025

(51) Int. Cl. G06F 9/30; G06F 9/448

(52) U.S. Cl. CPC G06F 9/30192; G06F 9/4494

(57) ABSTRACT

A computing system comprising one or more computing devices can provide, to a first machine-learned model, first documentation data indicative of an application programming interface (API). The computing system can receive, from the first machine-learned model, one or more inference outputs comprising data indicative of one or more instructions associated with the API, wherein the one or more inference outputs are generated based at least in part on the first documentation data. The computing system can generate, based at least in part on the one or more instructions associated with the API, second documentation data indicative of the API.

### BACKGROUND

The present disclosure relates generally to machine learning processes and machine-learned devices and systems. A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include providing, by a computing system comprising one or more computing devices to a first machine-learned model, first documentation data indicative of an application programming interface (API). The example method can include receiving, by the computing system from the first machine-learned model, one or more inference outputs comprising data indicative of one or more instructions associated with the API. In the example method, the one or more inference outputs can be generated based at least in part on the first documentation data. The example method can include generating, by the computing system based at least in part on the one or more instructions associated with the API, second documentation data indicative of the API.

In the example method, generating the second documentation data based at least in part on the one or more instructions associated with the API can include providing, by the computing system to the API, the one or more instructions. In the example method, generating the second documentation data based at least in part on the one or more instructions associated with the API can include receiving, by the computing system from the API, result data indicative of one or more results of executing the one or more instructions. In the example method, generating the second documentation data based at least in part on the one or more instructions associated with the API can include generating, by the computing system based at least in part on the result data, the second documentation data.

In the example method, generating the second documentation data can include providing, to the first machine-learned model or a second machine-learned model, at least one of: the first documentation data; the one or more instructions associated with the API; and data generated based on the one or more instructions associated with the API.

In the example method, the first machine-learned model can be a machine-learned agent configured to use one or more tools. The example method can include providing, by the computing system to the machine-learned agent, one or more queries configured to cause the machine-learned agent to call the API. In the example method, the one or more instructions can be received responsive to the one or more queries. The example method can include providing, by the computing system to the API, the one or more instructions. The example method can include receiving, by the computing system from the API, result data indicative of one or more results of executing the one or more instructions. The example method can include providing, by the computing system to the machine-learned agent, the result data. The example method can include receiving, by the computing system from the machine-learned agent, a first output generated based at least in part on the result data and the one or more queries. In the example method, generating the second documentation data can include generating based at least in part on one or more of the first output and the result data.

The example method can include providing, by the computing system to a second machine-learned model configured to evaluate computer code data, the one or more queries and the one or more instructions associated with the API. The example method can include receiving, by the computing system from the second machine-learned model, a second output evaluating the one or more instructions in relation to the one or more queries. In the example method, generating the second documentation data can include providing, to a third machine-learned model, the second output evaluating the one or more instructions in relation to the one or more queries.

In the example method, the second machine-learned model can include a model that was trained using error data comprising erroneous instructions associated with the API.

The example method can include providing, by the computing system to a second machine-learned model, the one or more queries and the result data. The example method can include receiving, by the computing system from the second machine-learned model, a second output evaluating the result data in relation to the one or more queries. In the example method, generating the second documentation data can include providing, to a third machine-learned model, the second output evaluating the result data in relation to the one or more queries.

The example method can include providing, by the computing system to a second machine-learned model, the one or more queries and the first output. The example method can include receiving, by the computing system from the second machine-learned model, a second output evaluating the first output in relation to the one or more queries. In the example method, generating the second documentation data can include providing, to a third machine-learned model, the second output evaluating the first output in relation to the one or more queries.

The example method can include generating, by a second machine-learned model based at least in part on the first documentation data, the one or more queries.

In the example method, the first machine-learned model can be configured to identify one or more parts of the API for which the first documentation data is incomplete. In the example method, the first machine-learned model can be configured to generate the one or more API instructions based on the one or more parts.

In the example method, the first machine-learned model can be a model that has been trained using one or more training examples. In the example method, each of the one or more training examples can include incomplete documentation data that was generated by removing a portion of third documentation data. In the example method, each of the one or more training examples can include a first query associated with the removed portion of the third documentation data.

The example method can include generating, by the first machine-learned model, test data comprising: at least one instruction associated with the API; and a test description output describing information to be learned from a result of the at least one instruction.

In the example method, generating the second documentation data can include generating, by the computing system, a plurality of candidate documentation examples. In the example method, generating the second documentation data can include determining, by the computing system based at least in part on the plurality of candidate documentation examples, the second documentation data.

In the example method, determining the second documentation data based at least in part on the plurality of candidate documentation examples can include selecting one or more candidate documentation examples based at least in part on a metric of verbosity.

In the example method, determining the second documentation data based at least in part on the plurality of candidate documentation examples can include providing, to the first machine-learned model or a second machine-learned model, third documentation data based on a first candidate documentation example of the plurality of candidate documentation examples. In the example method, determining the second documentation data based at least in part on the plurality of candidate documentation examples can include receiving, from the first machine-learned model or the second machine-learned model, at least one API instruction. In the example method, determining the second documentation data based at least in part on the plurality of candidate documentation examples can include determining, based at least in part on the at least one API instruction, whether to include the first candidate documentation example in the second documentation data.

The example method can include comparing, by the computing system, one or more first method signatures of the first documentation data to one or more second method signatures of a candidate documentation example to the first documentation data. The example method can include performing at least one of rejecting, by the computing system responsive to determining that the one or more second method signatures are materially different from the one or more first method signatures, the candidate documentation example; and including, by the computing system responsive to determining that the one or more second method signatures are not materially different from the one or more first method signatures, the candidate documentation example in the second documentation data.

In the example method, the API can be a first API. The example method can include providing, by the computing system to the first machine-learned model, third documentation data indicative of a second API. The example method can include receiving, by the computing system from the first machine-learned model, one or more inference outputs comprising data indicative of one or more instructions associated with the second API. In the example method, the one or more inference outputs can be generated based at least in part on the third documentation data. In the example method, generating the second documentation data can include generating combined documentation data based at least in part on the first documentation data and the third documentation data.

The example method can include generating, based at least in part on the second documentation data, data indicative of a suggested modification to the API.

The example method can include providing, by the computing system to the first machine-learned model or a second machine-learned model, the second documentation data and data indicative of a user query. The example method can include generating, by the first machine-learned model or the second machine-learned model, based at least in part on the second documentation data, one or more instructions associated with the API. The example method can include providing, by the computing system to the API, the one or more instructions to cause the API to perform one or more operations.

In the example method, the API can include an API for controlling a smart home device. In the example method, the one or more operations can include one or more of: activating or deactivating the smart home device; opening or closing the smart home device or a component thereof; setting a temperature value associated with the smart home device; and selecting an input to the smart home device.

In the example method, the second documentation data can include first requirement data indicative of one or more requirements for validly calling the API. In the example method, the first documentation data can lack the first requirement data. In the example method, the one or more instructions can comply with the one or more requirements.

In the example method, the one or more requirements can include one or more of: a minimum or maximum numerical value for one or more parameters of the one or more instructions; a set of valid values for one or more parameters of the one or more instructions; and a set of device states from which the one or more instructions can be executed.

In the example method, the one or more requirements can include at least one requirement wherein a violation of the at least one requirement would cause the API to encounter an exception or error.

Example aspects of the present disclosure provide one or more example non-transitory computer-readable media storing instructions that are executable by one or more processors to cause a computing system to perform example operations. In some implementations, the example operations can include providing, to a first machine-learned model, first documentation data indicative of an application programming interface (API). The example operations can include receiving, from the first machine-learned model, one or more inference outputs comprising data indicative of one or more instructions associated with the API, wherein the one or more inference outputs are generated based at least in part on the first documentation data. The example operations can include generating, based at least in part on the one or more instructions associated with the API, second documentation data indicative of the API.

Example aspects of the present disclosure provide an example computing system that includes one or more processors and one or more example non-transitory computer-readable media storing instructions that are executable by one or more processors to cause a computing system to perform example operations. In some implementations, the example operations can include providing, to a first machine-learned model, first documentation data indicative of an application programming interface (API). The example operations can include receiving, from the first machine-learned model, one or more inference outputs comprising data indicative of one or more instructions associated with the API, wherein the one or more inference outputs are generated based at least in part on the first documentation data. The example operations can include generating, based at least in part on the one or more instructions associated with the API, second documentation data indicative of the API.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles

### BRIEF DESCRIPTION OF THE DRAWINGS

FIG. 1 is a block diagram illustrating an example system for generating improved API documentation according to example implementations of aspects of the present disclosure;

FIG. 2 is a block diagram illustrating an example system for generating improved API documentation according to example implementations of aspects of the present disclosure;

FIG. 3 is a block diagram illustrating an example system for generating improved API documentation according to example implementations of aspects of the present disclosure;

FIG. 4 is a block diagram illustrating an example system for performing actions using a machine-learned agent based on improved API documentation according to example implementations of aspects of the present disclosure;

FIG. 5 is a flow chart diagram illustrating an example method for enhancing API documentation according to example implementations of aspects of the present disclosure

FIG. 6 is a flow chart diagram illustrating an example method for training a machine-learned model according to example implementations of aspects of the present disclosure;

FIG. 7 is a block diagram of an example processing flow for using machine-learned model(s) to process input(s) to generate output(s) according to example implementations of aspects of the present disclosure;

FIG. 8 is a block diagram of an example sequence processing model according to example implementations of aspects of the present disclosure;

FIG. 9 is a block diagram of an example technique for populating an example input sequence for processing by a sequence processing model according to example implementations of aspects of the present disclosure;

FIG. 10 is a block diagram of an example model development platform according to example implementations of aspects of the present disclosure;

FIG. 11 is a block diagram of an example training workflow for training a machine-learned model according to example implementations of aspects of the present disclosure;

FIG. 12 is a block diagram of an inference system for operating one or more machine-learned model(s) to perform inference according to example implementations of aspects of the present disclosure;

FIG. 13 is a block diagram of an example networked computing system according to example implementations of aspects of the present disclosure;

FIG. 14 is a block diagram of an example computing device according to example implementations of aspects of the present disclosure; and

FIG. 15 is a block diagram of an example computing device according to example implementations of aspects of the present disclosure.

### DETAILED DESCRIPTION

Generally, the present disclosure is directed to systems and methods for automatically enhancing application programming interface (API) documentation using machine learning. A computing system can obtain first documentation associated with an API. The computing system can generate, using one or more machine-learned models, one or more computer-executable instructions for calling the API. Based on the computer-executable instruction(s), the computing system can generate updated API documentation. For example, in some instances, the computing system can provide the computer-executable instruction(s) to the API; receive one or more results from the API responsive to the instruction(s); and generate updated documentation based on the result(s).

In some instances, a system for automatically enhancing API documentation can include an agent-based system configured to update API documentation based on output(s) of a machine-learned agent configured to use API tools. Additionally or alternatively, in some instances, a system for automatically enhancing API documentation can include a targeted testing system configured to analyze first API documentation to identify potential problems with the first API documentation (e.g., ambiguous content, missing content, etc.) and generate test instructions based on the potential problems.

In some targeted testing approaches, a computing system can provide first API documentation to a machine-learned model configured (e.g., fine-tuned, prompted, etc.) to identify information that may be missing from the first documentation and generate one or more API test cases to learn the missing information. A generated test case can include, for example, one or more computer-executable instructions for calling the API. Additionally, in some instances, a generated test case can include additional data, such as data (e.g., natural language data, etc.) indicating what missing information can be learned from executing the generated instructions. A computing system can call the API using the computer-executable instructions, and can provide a result of the API to a machine-learned model configured (e.g., fine-tuned, prompted, etc.) to generate updated API documentation based on API result data. In some instances, the computing system can further provide other data to the machine-learned model, such as test case data (e.g., data describing what information can be learned from the result data); initial API documentation data; or other data.

In some agent-based approaches, a computing system can provide one or more queries (e.g., queries comprising the first API documentation, etc.) to a machine-learned agent configured to use API tools. Based on the one or more queries, the machine-learned agent can generate one or more API calls; receive API result(s) responsive to the API call(s); and generate inference output(s) based on the API call(s). Based on one or more of the first documentation, queries, API call(s), API result(s), and inference output(s), the computing system can generate updated documentation for the API (e.g., using a machine-learned sequence processing model, etc.).

In some instances, a computing system can use one or more machine-learned critics to evaluate one or more aspects of a machine-learned agent’s process in responding to a query. A critic can include, for example, a machine-learned model (e.g., autorater, etc.) configured (e.g., fine-tuned, prompted, etc.) to evaluate a response trajectory of a machine-learned agent based on one or more criteria. In some instances, a plurality of machine-learned critics can be used to evaluate distinct aspects of a response trajectory of the machine-learned agent. For example, in some instances, a code critic can evaluate one or more API instructions generated by the machine-learned agent (e.g., based on a comparison between the API instruction(s) and the first documentation; between the API instruction(s) and the query; or other data) , such as by evaluating a selection of arguments included in the API instruction(s); evaluating a value assigned to each included argument; or other evaluation. As another example, in some instances, an API result critic can analyze a result provided by the API, such as by analyzing whether the result was helpful in responding to the query; analyzing whether the result could be confidently predicted from the first documentation; or other analysis. As another example, in some instances, an inference output critic can analyze an inference output of the machine-learned agent (e.g., by comparing the inference output to the query, etc.). In some instances, a plurality of evaluation outputs can be provided to a machine-learned model (e.g., sequence processing model, generative language model, etc.) to cause the model to generate updated API documentation based on the evaluation outputs.

In some instances, a computing system can generate queries for a machine-learned agent based on the first documentation, or can obtain (e.g., receive, retrieve, etc.) queries in another manner. For example, in some instances, a computing system can provide the first documentation to a machine-learned model configured (e.g., fine-tuned, prompted, etc.) to generate a set of queries (e.g., natural language queries, etc.) configured to cause a machine-learned agent to generate a broad range of API calls in responding to the queries, such as a range of API calls that may include most (e.g., all, etc.) of a set of available API functions. As another example, in some instances, a computing system can obtain (e.g., receive, retrieve, etc.) a data set comprising queries (e.g., natural language queries, etc.) provided by human users, or other queries.

In some instances, a plurality of candidate updates to the first documentation can be generated, and updated documentation can be generated based on the plurality of candidates. For example, in some instances, a candidate update can be compared to the first documentation, and can be rejected if the candidate update materially changes a signature of an API function (e.g., by changing a function name; number or type of parameters; or the like). As another example, in some instances, a plurality of candidate updates can be tested (e.g., by using a machine-learned agent to respond to queries based on candidate updated API documentation, etc.), and one or more candidate updates can be selected based on the test results. In some instances, a plurality of candidate updates can be scored based on one or more other criteria, such as a metric of verbosity (e.g., documentation length in relation to a context window size, etc.) or other criteria.

In some instances, systems and methods according to aspects of the present disclosure can be applied to documentation associated with one API or multiple APIs. For example, in some instances, a computing system can be provided with documentation associated with two or more APIs; generate API calls based on the documentation; and update the documentation based on the API calls. In some instances, an agent-based approach to updating multi-API documentation can include generating a query set configured to target a decision boundary between a first API and a second API. For example, in instances where a machine-learned agent is configured to select an API from a plurality of APIs, a machine-learned query generation model can be configured to identify operation(s) for which two or more APIs might be suitable, and generate one or more test queries based on the operation(s). As another example, in some instances, a candidate update for multi-API documentation can include data indicating which API should be called for certain operations.

In some instances, API documentation that has been updated (e.g., improved, etc.) according to methods described herein can be provided to a machine-learned agent, which can use the updated API documentation to respond to queries (e.g., user queries, etc.). For example, a machine-learned agent can receive updated API documentation, a user query, and other data. Based on the query and the updated API documentation, the machine-learned agent can call the API; receive result data from the API responsive to the call; and provide an inference output to a user based on the result data and the query. Additionally or alternatively, in some instances, updated API documentation can be used in another manner, such as to generate one or more suggestions for modifying the API; to automatically rewrite API code; or in another manner.

Example embodiments according to some aspects of the present disclosure can provide for a number of technical effects and benefits, such as improvements to computing technology (e.g., machine learning technology). For example, in some instances, systems and methods according to some aspects of the present disclosure can provide improved technical performance (e.g., machine-learned inference accuracy, etc.) compared to some alternative implementations. As another example, in some instances, systems and methods according to some aspects of the present disclosure can provide similar technical performance at reduced computational cost compared to some alternative implementations.

In some instances, systems and methods according to some aspects of the present disclosure can provide improved technical performance (e.g., machine-learned inference accuracy, etc.) compared to some alternative implementations. For example, in some instances, systems and methods according to aspects of the present disclosure can provide improved (e.g., more accurate, better configured for use with a machine-learned agent, etc.) API documentation generation according to some alternative implementations. As another example, in some instances, API documentation that has been updated according to some aspects of the present disclosure can be provided to a machine-learned model (e.g., API tool-use agent, etc.) configured to generate API instructions based on the documentation; in such instances, updated API documentation according to some aspects of the present disclosure can cause the machine-learned model to generate more accurate (e.g., having fewer errors, such as fewer syntax errors, bugs, exceptions, etc.; corresponding more accurately to a user query; etc.) API calls compared to some alternative (e.g., non-updated, etc.) API documentation. Additionally, in some instances, improved API calls, such as API calls that are better aligned with a user query to a machine-learned agent, can lead to further technical improvements such as improved (e.g., more accurate, better-aligned, etc.) API results, improved (e.g., more accurate; better aligned with user query; etc.) inference outputs based on the API results; or other technical benefits. As another example, in some instances, systems and methods according to aspects of the present disclosure can be used to automatically rewrite API code, thereby improving the functioning of the API itself in some instances (e.g., by removing redundant or unused parameters, thereby reducing a memory footprint of the API; or other functional improvement).

In some instances, systems and methods according to some aspects of the present disclosure can perform similar (e.g., same, etc.) actions or provide similar (e.g., same, etc.) technical performance at reduced computational cost compared to some alternative implementations. For example, in some instances, systems and methods that can improve an inference accuracy of a machine-learned model having a given computational cost (e.g., given number of parameters, model architecture, etc.) can be adapted to reduce a computational cost of machine-learned inference at a given accuracy. For example, in some instances, an accuracy of a machine-learned model can scale with a complexity (e.g., number of parameters, number of layers, number of operations per forward pass, computational complexity of each operation or parameter, number of bits used to represent each parameter, etc.) of the machine-learned model. In such instances, a system that can provide improved inference accuracy of a machine-learned model at a given computational complexity (e.g., given architecture, given number of parameters, given precision, etc.) can be adapted to provide similar inference accuracy at reduced computational complexity. In this manner, for instance, systems and methods according to aspects of the present disclosure can reduce a computational cost of machine-learned inference, thereby improving the functioning of a computing system or other technology (e.g., machine learning technology).

As another example, in some instances, improved inference accuracy can lead to a reduced need to repeat (e.g., resample, etc.) one or more inference operations, thereby reducing a computational cost of generating a final inference output. For example, in some instances, a machine learning system may be configured to evaluate an initial inference output according to one or more quality control evaluations (e.g., machine-learned evaluations, user evaluations, etc.). In some instances, the machine learning system may be configured to reject a candidate inference output and generate a new inference output in response to a failed quality control evaluation (e.g., “thumbs down” input from a user; failed evaluation from an entailment classifier; failed evaluation from an autorater evaluating alignment with an input query; etc.). In such instances, improved inference accuracy can reduce a rejection frequency, thereby reducing a number of candidate inference outputs that must be generated to satisfy a given number of user queries, thereby reducing a computational cost of machine-learned inference compared to some alternative implementations.

As another example, in some instances, systems and methods according to some aspects of the present disclosure can evaluate candidate API updates according to various metrics, including metrics associated with a computational cost of inference using the updated API (e.g., metrics of verbosity, etc.). For example, in some instances, a more verbose API documentation input may increase a computational cost of machine-learned inference compared to a less verbose API documentation input (e.g., due to a memory cost, electricity cost, or processor usage cost of processing more tokens of the verbose API; due to an increased architectural complexity required to process increased context window sizes; etc.). Advantageously, systems and methods according to some aspects of the present disclosure can weigh one or more benefits of a candidate update (e.g., improved inference quality) against one or more costs of the candidate update (e.g., increased verbosity or other metric, etc.) and select a candidate update having a better (e.g., best) cost-benefit tradeoff, thereby reducing a computational cost of inference and improving the functioning of the computing system compared to some alternative implementations.

Various example implementations are described herein with respect to the accompanying Figures.

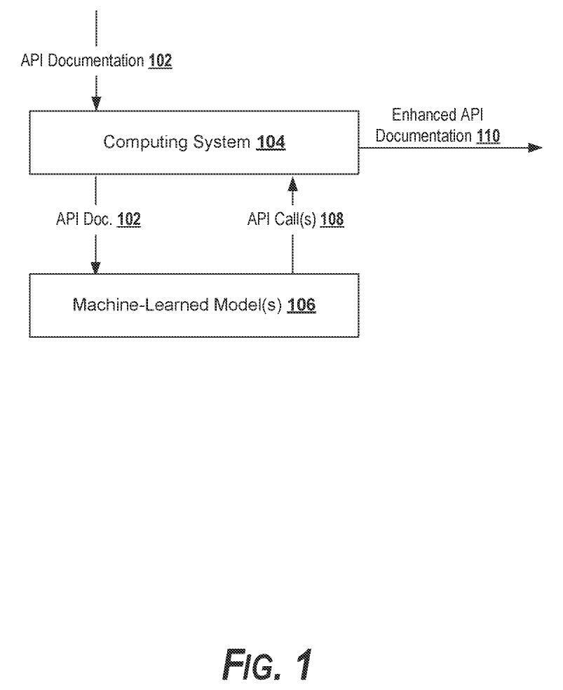

FIG. 1 is a block diagram illustrating an example system for generating improved API documentation according to example implementations of aspects of the present disclosure. A computing system 104 can obtain API documentation 102. The computing system 104 can provide the API documentation 102 to one or more machine-learned models 106. Based on the API documentation 102, the machine-learned model(s) can generate one or more API calls 108. Based on the API call(s) 108, the computing system 104 can generate enhanced API documentation 110.

API documentation 102 can generally include or otherwise represent various types of data. API documentation 102 can include one type or many different types of data. Example data types for API documentation 102 can include, for example, text data, binary data, language data (e.g., computer coding language, natural language, etc.), sequence data, or other data types.

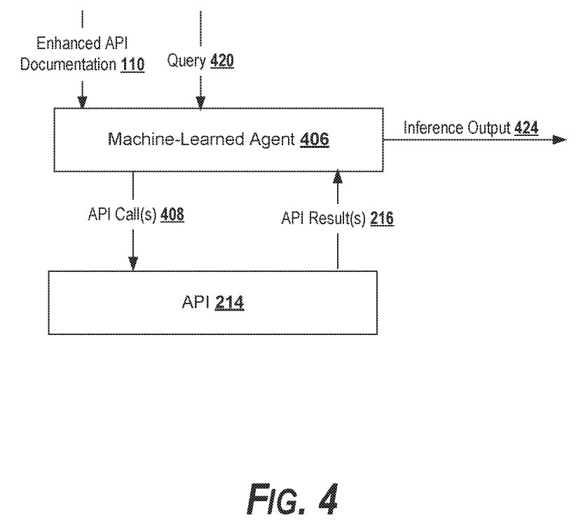

In some instances, API documentation 102 can include one or more of: one or more function signatures associated with one or more operations (e.g., methods, functions, subroutines, etc.) that can be performed using an application programming interface (API); one or more descriptions (e.g., natural language descriptions, docstrings, comments, etc.) associated with one or more operations that can be performed using an API; or other API data. An API can include, for example, an interface for accessing (e.g., performing, causing to be performed, etc.) one or more computing operations using one or more signals (e.g., network signals such as hypertext transfer protocol (HTTP) requests or the like), requests, instructions (e.g., computer- executable instructions, computer-readable instructions, object code, source code, bytecode, etc.), or other data indicative of an operation to be performed (e.g., operation name associated with an API wrapper or glue code, operation identifier number, etc.). In some instances, API documentation 102 can include documentation associated with one API or multiple APIs. In some instances, API documentation 102 can include shell documentation (e.g., minimal or bare- bones documentation, etc.) to be enhanced using systems and methods described herein, such as API documentation 102 comprising only method signatures and no natural language description. Similarly, in some instances, API documentation 102 can include a computer code file (e.g., without description content, etc.) from which a computing system can identify (e.g., extract, parse, etc.) function signatures (e.g., based on a syntax or semantic keyword(s) of a programming language, etc.). In other instances, API documentation 102 can include existing description content (e.g., docstring content, natural language description content, human-written description content, computer-generated description content, etc.), which can be further enhanced (e.g., added to, edited, modified, deleted from, etc.) to improve the functionality of one or more systems that use an API associated with the API documentation 102 (e.g., systems described below with respect to FIG. 4, etc.).

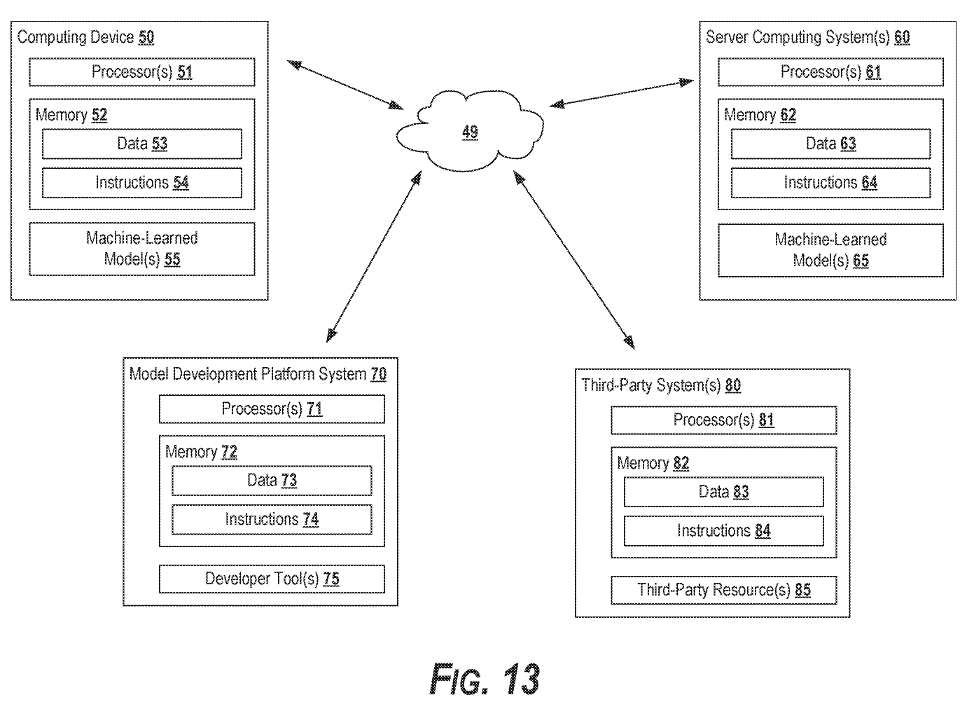

A computing system 104 can be or include one or more software, firmware, or hardware components configured to generate enhanced API documentation 110 based on API documentation 102. In some instances, the computing system 104 can be, comprise, be comprised by, or share one or more properties with a computing device or system described below with respect to FIGS. 13-15 (e.g., computing device 50, third-party system 80, computing device 98, computing device 99, etc.). In some instances, a computing system 104 can include one or more software, firmware, or hardware components to obtain (e.g., retrieve, extract, parse, etc.) API documentation 102 from a source. For example, in some instances, systems according to aspects of the present disclosure can be embodied in a binary configured to auto-load API documentation 102 based on data indicative of a location (e.g., folder, git repository, memory location, etc.) of the API documentation 102 or corresponding API code (e.g., source code from which one or more function signatures can be parsed, etc.), and to generate enhanced API documentation 110 based on the loaded API documentation 102. Other embodiments are possible.

The machine-learned model(s) 106 can include one or more machine-learned models. The machine-learned model(s) 106 can include various model architectures, such as various neural network model architectures. An example model architecture for a machine-learned model(s) 106 can include a sequence processing model architecture (e.g., a transformer model). For example, the machine-learned model(s) 106 can be configured to receive an input sequence and generate an output sequence. For instance, the machine-learned model(s) 106 can be configured to generate an output sequence where elements of the output sequence are predicted based on the elements of the input sequence. In some instances, a machine-learned model 106 can include a model architecture having an attention mechanism (e.g., self-attention). In some instances, a machine-learned model 106 can be a pre-trained model (e.g., pretrained using large-scale unsupervised learning). In some instances, a machine-learned model 106 can be fine-tuned over one or more fine-tuning datasets, such as a fine-tuning dataset associated with one or more specialized generation tasks.

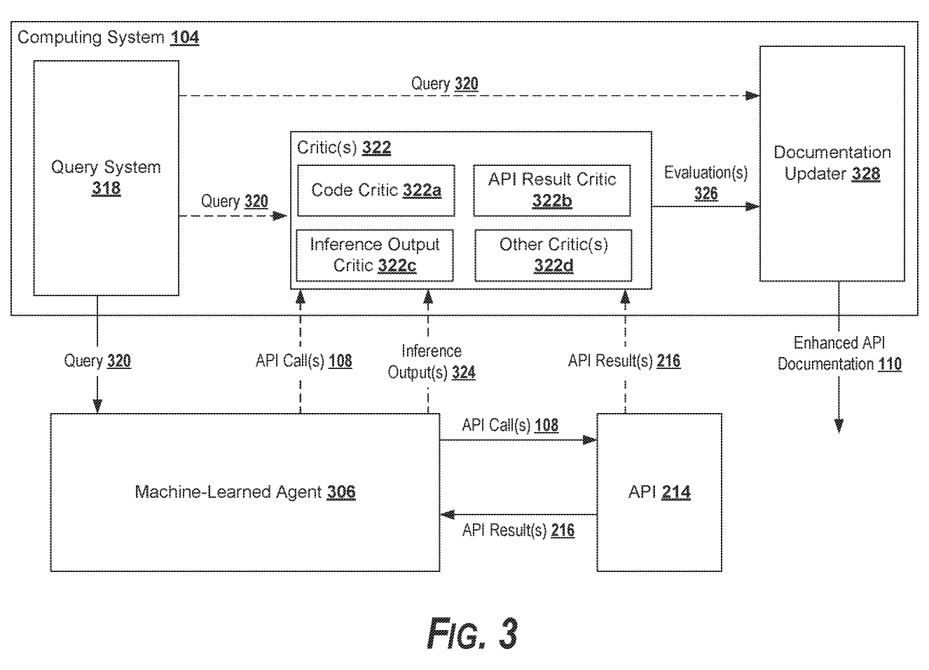

In some instances, the machine-learned model(s) 106 can include a machine-learned agent, such as a machine-learned agent configured to access one or more tools via one or more APIs. In some instances, a machine-learned model 106 can include an agent configured to perform one or more tasks (e.g., using one or more API tools) in response to one or more task requests (e.g., natural language requests, user requests, etc.) provided as input. In some instances, a machine-learned model 106 can include an agent configured to perform task(s) using a reasoning process, such as a chain-of-thought reasoning process, reasoning chain, tree-of-thought reasoning process, search-based reasoning process (e.g., Q-star or R-star search, tree search, etc.), or the like. Further details of an example system for generating enhanced API documentation 110 using a machine-learned agent are provided below with respect to FIG. 3.

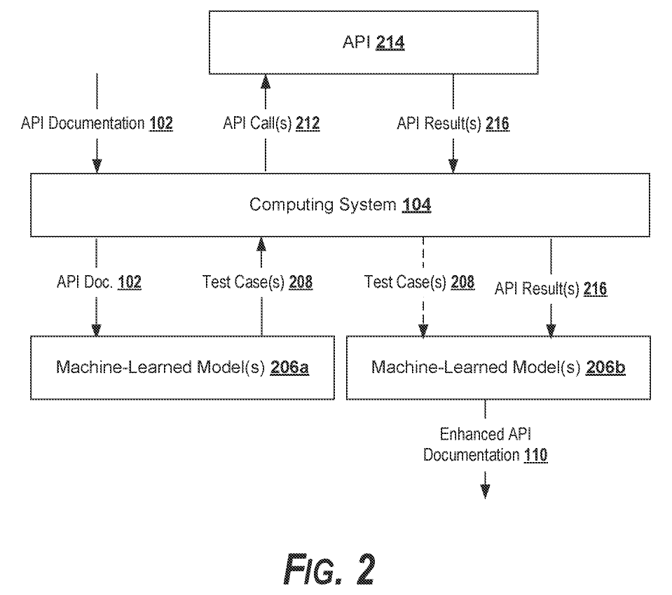

Additionally or alternatively, in some instances, the machine-learned model(s) 106 can include one or more models configured to analyze API documentation 102 to identify potential problems (e.g., potential areas of incompleteness, omitted description content, ambiguous description content, etc.) and generate API calls 108 based on the potential problems. For example, in some instances, a machine-learned model 106 can identify omitted or ambiguous data associated with API documentation 102, and can generate test API calls 108 to gather data to clarify or add to the API documentation 102. Further details of an example system for analyzing API documentation 102 and generating API calls 108 based on the analysis are provided below with respect to FIG. 2.

In some instances, a system for generating enhanced API documentation 110 can include a system that uses both agent-based documentation enhancement and analysis-based documentation enhancement. For example, in some instances, generating enhanced API documentation 110 can include performing a preliminary analysis-based enhancement (e.g., according to methods described below with respect to FIG. 2, etc.), followed by a further agent-based enhancement (e.g., according to methods described below with respect to FIG. 3, etc.) using a machine-learned agent that will also be used in production (e.g., according to methods described below with respect to FIG. 4, etc.). Other implementations are possible.

In some instances, a machine-learned model 106 used to generate enhanced API documentation 110 can include a model that is the same as or different from a model that will be used (e.g., in production, etc.) to perform tasks using an API associated with the enhanced API documentation 110. For example, in some instances, a first machine-learned agent can be used to generate enhanced API documentation 110 (e.g., according to methods described below with respect to FIG. 3, etc.), and the first machine-learned agent can be used in production to perform requested operations using an API associated with the enhanced API documentation 110 (e.g., as described below with respect to FIG. 4, etc.).

An API call 108 can generally include or otherwise represent various types of data. An API call 108 can include one type or many different types of data. Example data types for an API call 108 can include, for example, text data, binary data, language data (e.g., natural language, programming language, etc.), binary data, computer code data (e.g., source code, object code, bytecode, etc.), sequence data, or other data types.

In some instances, an API call 108 can include an instruction configured to access an API associated with the API documentation 102. For example, in some instances, an API call 108 can include an instruction having one or more properties (e.g., function name, formatting, syntax, parameter name(s), parameter count, parameter types, etc.) that correspond to or match a function signature contained in the API documentation 102. In some instances, an API call can include one or more signals (e.g., network signals such as hypertext transfer protocol (HTTP) requests or the like), requests, instructions (e.g., computer-executable instructions, computer-readable instructions, object code, source code, bytecode, etc.), or other data indicative of an operation to be performed (e.g., operation name associated with an API wrapper or glue code, operation identifier number, etc.).

In some instances, generating an API call 108 can include providing API documentation 102 (e.g., with or without other input context, etc.) to a machine-learned model 106 configured (e.g., trained, fine-tuned, prompted, etc.) to output API call(s) 108 based on one or more inputs comprising the API documentation 102. For example, in some instances, generating an API call 108 can include providing, to a machine-learned model 106, API documentation 102 along with in-context learning content (e.g., instruction content, chain-of-thought content, few-shot example content, least-to-most prompting content, etc.) to cause the machine-learned model 106 to output API call(s) 108 based on the API documentation 102. In some instances, in-context learning content can include content to cause the machine-learned model 106 to identify edge cases, missing description data, ambiguous description data, or the like, and to generate API calls 108 to test a functionality of the API to gather additional data. In some instances, in-context learning content can include content to cause machine-learned model 106 to generate API calls 108 based on one or more tasks to be performed using the API calls 108 (e.g., one or more user queries to be satisfied by a machine-learned agent, etc.). As another example, in some instances, generating an API call 108 can include providing API documentation 102 to a machine-learned model 106 that was trained (e.g., fine-tuned, etc.) to generate API calls 108 based on API documentation 102 (e.g., with or without additional input context, etc.), such as a machine-learned model 106 that was trained using training examples comprising input-output pairs comprising an API documentation input and corresponding API call output(s). Further details of some example systems for generating API calls 108 are provided below with respect to FIGS. 2 and 3.

Enhanced API documentation 110 can have, for example, any property described herein with respect to API documentation 102, and vice versa. In some instances, enhanced API documentation 110 can include API documentation generated based on API documentation 102, such as API documentation comprising the API documentation 102 plus one or more additions (e.g., added natural language description content, etc.); minus one or more deletions; or API documentation 102 modified with one or more edits, corrections, or the like. In some instances, enhanced API documentation 110 can include one or more function signatures (e.g., method signatures, subroutine signatures, etc.) indicative of a method for calling one or more functions associated with an API. A function signature can include, for example, any data indicative of a method for causing one or more computing operations to be performed using an API. Example function signatures can include, for example, a function signature (e.g., in a format associated with a computer programming language, etc.) comprising a function name and zero or more parameters (e.g., required parameters, optional parameters, etc.) associated with the function; an action name or action identifier to be generated as an action selection output (e.g., action selection of a machine-learned agent, etc.); or other data indicative of a method for causing one or more computing operations to be performed using an API.

In some instances, a set of function signatures of the API documentation 110 can include some or all of a set of function signatures of API documentation 102 used to generate the API documentation 110. For example, in some instances, API documentation 102 can include documentation associated with one API or multiple APIs, and a set of function signatures of the enhanced API documentation 110 can include documentation comprising function signatures associated with all functions of the API(s), or a subset thereof (e.g., subset curated based on the needs of a system comprising a machine-learned agent, etc.). In some instances, enhanced API documentation 110 generated based on API documentation 102 associated with multiple APIs (e.g., multiple respective API documentation 102 inputs for each respective API, combined API documentation 102 input associated with multiple APIs, etc.) can include combined enhanced API documentation 110 comprising data indicative of each of the multiple APIs; separate enhanced documentation 110 data comprising a plurality of single-API enhanced documentation 110 outputs; or other format.

In some instances, generating enhanced API documentation 110 can include providing one or more API calls to an API; receiving result data from the API; and generating enhanced API documentation 110 based on the result. For example, in some instances, generating enhanced API documentation 110 can include providing result data (e.g., with or without additional data such as API documentation 102, data derived from the result data, etc.) to a machine-learned model to cause the model to generate enhanced API documentation 110 based on the result data. Further details of some example methods for generating enhanced API documentation 110 using a machine-learned model are provided below with respect to FIGS. 2 and 3. As another example, in some instances, generating enhanced API documentation 110 can include non-machine-learned operations, such as by adding all or part of the result data, or other data generated from the result data, to the API documentation 102 (e.g., according to a structured format or template, such as a few-shot prompting template for providing example input-output pairs to a machine-learned model, etc.). For example, in some instances, generating enhanced API documentation 110 can include adding, to API documentation 102, 110, one or more example input-output pairs comprising an API call 108 and corresponding result data received in association with the API call 108. In some instances, the example input-output pairs can be provided in a structured (e.g., JSON-structured or XML-structured format, etc.) or templated (e.g., according to a few-shot prompting template, etc.) format. In some instances, generating enhanced API documentation 110 can include adding, to the API documentation 102, data derived from API call 108 result data, such as statistical data (e.g., mean, median, range, minimum, maximum, etc.), parameter data (e.g., accepted data types of function parameters, minimum or maximum acceptable input value for a parameter, etc.), or other data derived from API call 108 result data.

In some instances, enhanced API documentation 110 can include all-new data or updated version(s) of existing data. For example, in some instances, enhanced API documentation 110 can include all-new documentation data (e.g., a new documentation file separate from a file associated with API documentation 102, etc.); an updated version of API documentation 102 (e.g., updated file overwriting an API documentation 102 file, etc.); one or more update values for modifying API documentation 102 data (e.g., suggested additions, deletions, or updates; redline content; tracked change content; etc.); or other updated API documentation.

In some instances, a plurality of candidate documentation examples can be generated, and new documentation can be generated based on the plurality of candidates. For example, in some instances, candidate updated documentation can be compared to the first documentation, and can be rejected if the candidate documentation materially changes a signature of an API function (e.g., by changing a function name; number or type of parameters; or the like). A material change to a function signature can include, for example, a change that would cause an output (e.g., computer-executable instruction, action selection output, method call, etc.) that conforms to the changed function signature to be unsuitable for calling the API. An output can be unsuitable for calling an API if, for example, providing the output to the API would cause the API to return an error message; cause the API to do nothing; otherwise fail to perform an action indicated by the output; or the like. In some instances, a material change to a function signature can include any change indicative of a purported change in behavior of the function described by the function signature. A change to a function signature can be immaterial if, for example, the change has no relevance to, or effect on, operations performed by the API when called according to the function signature. As a non-limiting illustrative example, if a first programming language is configured to process input parameters to a function based on the parameters’ position in an ordering (e.g., ordered list, etc.) of input parameters, without regard to parameter name(s) used by an entity that is calling the function, then a change to a parameter name of a function signature associated with that first programming language may be immaterial. However, if a second programming language is configured to process input parameters based on a parameter name used in a function call, then a change to a parameter name of a function signature associated with the second programming language can be a material change.

As another example, in some instances, a plurality of candidate documentation items (e.g., edits, updates, full-API documentation outputs, etc.) can be tested (e.g., by using a machine-learned agent to respond to queries based on candidate updated API documentation, etc.), and one or more candidates can be selected based on the test results. Further details of some example methods for testing candidate updates using a machine-learned agent are provided below with respect to FIG. 3.

In some instances, a method described herein can be repeated one or more times to further improve the enhanced API documentation 110. For example, in some instances, enhanced API documentation 110 can be provided to a machine-learned model 106 as API documentation 102; the machine-learned model 106 can generate API call(s) 108 based on the enhanced API documentation 110; and further-enhanced API documentation can be generated based on the API call(s) (e.g., according to any method described herein with respect to FIGS. 1-3, etc.). In some instances, such a process can be repeated until a metric of quality (e.g., benchmark score on a testing benchmark for machine-learned agents, etc.) exceeds a predetermined threshold; until a maximum API enhancement budget (e.g., computational cost budget such as processor usage budget, memory bandwidth budget, time budget, etc.; financial budget; or other budget) is reached; or until another endpoint is reached.

In some instances, enhanced API documentation 110 can be used for various systems and methods. For example, in some instances, enhanced API documentation 110 can be used by a machine-learned agent configured to respond to user requests using one or more API tools. Further details of an example system for using enhanced API documentation 110 to perform tasks using a machine-learned agent are provided below with respect to FIG. 4. Additionally or alternatively, in some instances, enhanced API documentation 110 can be used in another manner, such as to generate one or more suggestions for modifying the API (e.g., suggested modification to API source code, etc.); to automatically rewrite API code; or in another manner. For example, in some instances, enhanced API documentation 110 can be provided to a machine-learned model configured (e.g., fine-tuned, prompted using in-context learning content such as instruction content, chain-of-thought or few-shot prompt content, etc.) to generate one or more code improvement suggestions based on the enhanced API documentation data 110. For example, in some instances, a machine-learned model can be provided with content (e.g., trained with training examples, provided with in-context learning content as input, etc.) indicative of one or more common error patterns to cause the machine-learned model to output code improvement suggestions based on the error pattern(s). As a non-limiting illustrative example, an error pattern can include a parameter that has no effect on an output of a function called using the parameter; a parameter that has an effect that is different from an effect described in API documentation 102; a parameter having a data type that is unsuitable or suboptimal; or other error pattern. In some instances, a code improvement suggestion can include a suggestion to rename one or more parameters; change one or more parameter data types; add new parameter(s); remove parameter(s); or other change. In some instances, generating code improvement suggestions can include one or more non-machine-learned operations, such as generating an improvement suggestion based on a mapping from a predefined error pattern to a predefined suggestion template. As a non-limiting illustrative example, an error pattern comprising a parameter with no effect on a result of an API call 108 can be mapped to a suggestion to delete the parameter.

FIG. 2 is a block diagram illustrating an example system for generating updated API documentation 110 based on test cases 208 according to example implementations of aspects of the present disclosure. A computing system 104 can obtain API documentation 102. The computing system 104 can provide the API documentation 102 to a first machine-learned model 206a. Based on the API documentation 102, the first machine-learned model 206a can generate one or more test cases 208 comprising one or more API calls 212. The computing system 104 can provide, to an application programming interface (API) 214, the API call(s) 212. The computing system 104 can receive, from the API 214, one or more API results 216. The computing system can provide the API result(s) 216 to a second machine-learned model 206b, either alone or in combination with other data (e.g., test case 208 data, etc.). Based at least in part on the API result(s) 216, the second machine-learned model 206b can generate enhanced API documentation 110.

In some instances, a machine-learned model 206a, 206b can be, comprise, be comprised by, or otherwise share one or more properties with a machine-learned model 106. For example, in some instances, a machine-learned model 206a, 206b can have any property described herein with respect to a machine-learned model 106, and vice versa.

In some instances, a machine-learned model 206a can include a model configured (fine-tuned, prompted, etc.) to identify potential ways in which API documentation 102 may be incomplete, such as omitted documentation data; ambiguous documentation data; or the like. In some instances, data indicative of incomplete documentation can include data indicative of one or more parameters for which a data type; minimum allowed value; maximum allowed value; parameter description; or other content may be unknown or not included in the API documentation 102. In some instances, data indicative of incomplete documentation can include data indicative of a boundary (e.g., logical boundary, decision boundary, boundary between numerical ranges, edge case, etc.) between two conditions, wherein a behavior of the API at or near the boundary is not described in the API documentation 102. As a non-limiting illustrative example, if API documentation 102 contains description content describing a behavior of the API when a first parameter is negative, and description content describing a behavior of the API when the first parameter is positive, then a boundary between the negative condition and positive condition can exist when the first parameter is equal to zero. Continuing the non-limiting illustrative example, in some instances, a machine-learned model 206a can include a model configured (e.g., fine-tuned, prompted, etc.) to identify the boundary; determine whether the API documentation 102 includes description content defining a behavior of the API at the boundary (e.g., when the first parameter is equal to zero); and generate test case(s) 208 based on the boundary if the API documentation 102 ambiguously describes or does not describe a behavior of the API at the boundary.

In some instances, API documentation 102 can include data indicative of one API 214 or multiple APIs 214. For example, in some instances, API documentation 102 can include data indicative of multiple APIs 214, and a machine-learned model 206a can generate one or more first test cases 208 based on a first API 214; one or more second test cases based on a second API 214; one or more third cases based on a relationship between the first API 214 and second API 214; and so on (e.g., fourth test cases based on third API 214 or relationship first, second, and third APIs 214, etc.). For example, in some instances, a boundary can include a decision boundary between a first function associated with the first API 214 and a second function associated with the second API 214, such as a second function providing functionality that is similar to (e.g., same as, etc.) the first function. In some instances, a machine-learned model 206a can include a machine-learned model configured (e.g., fine-tuned, prompted, etc.) to identify one or more boundaries between a first API 214 and second API 214, and to generate test case(s) 208 based on the one or more boundaries (e.g., according to method(s) described above in the preceding paragraph, etc.).

In some instances, configuring a machine-learned model 206a to identify data indicative of incomplete documentation can include training the machine-learned model 206a on a plurality of training examples comprising incomplete API documentation and corresponding API calls associated with the incomplete API documentation. For example, in some instances, one or more incomplete API documentation examples can be generated by removing (e.g., automatically removing, such as according to a random process, etc.) one or more portions of existing API documentation data. In some instances, one or more API calls can be determined (e.g., generated by a machine-learned model; generated according to a template, mapping, or other no-machine-learned approach; provided by a human being etc.) based on the removed portion(s), and a training example can be provided to the machine-learned model 206a based on the API call and incomplete API documentation example. For example, a training example can include an input-output pair comprising an incomplete API documentation example as a training input and an API call as a corresponding training output.

In some instances, configuring a machine-learned model 206a to identify data indicative of incomplete documentation can include providing the machine-learned model 206a with in-context learning content, such as instruction content to cause the machine-learned model 206a to identify data indicative of incomplete API documentation (e.g., “Please read the following API documentation and identify any parts of the documentation that are ambiguous,” etc.); few-shot example content or chain-of-thought example content; or other in-context learning content. In some instances, a few-shot example can have any property described above with respect to a training example, and can be generated in any manner described above with respect to a training example. In some instances, a chain-of-thought example can include an example input-reasoning-output tuple. In some instances, an input and output of a chain-of-thought example can have any property described above with respect to a few-shot or training example. A reasoning component of an input-reasoning-output tuple can include data indicative of a reasoning process for arriving at the example output of the input-reasoning-output tuple. In some instances, a reasoning component of an input-reasoning-output tuple can be provided by a human being or generated by a machine-learned model based on one or more of incomplete documentation data; removed portions associated with the incomplete documentation data; API calls associated with the incomplete documentation data; or other data.

In some instances, a machine-learned model 206a can be configured (e.g., fine-tuned, prompted, etc.) to generate API calls 108 based on data indicative of incomplete documentation, such as data identified by a machine-learned model 206a that is the same as or different from a machine-learned model 206a used to generate the API calls 108. For example, in some instances, a first machine-learned model 206a can be prompted with in-context learning content to cause the first machine-learned model 206a to identify data indicative of incompleteness of the API documentation 102, and a second machine-learned model 206a can be provided with content (e.g., in-context learning content such as instruction(s), few-shot example(s), chain-of-thought example(s), etc.) comprising an output of the first machine-learned model 206a. For example, in some instances, a second machine-learned model 206a can be prompted with an output of a first machine-learned model 206a, along with an instruction to generate one or more API calls 108 based on the output of the first machine-learned model 206a (e.g., "Based on the following API documentation and the following explanation of something we do not know about the API, please generate one or more API calls we can use to test the API and learn the thing we do not know.”, etc.).

In some instances, a machine-learned model 206b can include a model configured (e..g, fine-tuned, prompted, etc.) to generated enhanced API documentation 110 based on one or more of test case(s) 208, API call(s) 212, API result(s) 216, API documentation 102, or other data. For example, in some instances, configuring a machine-learned model 206b to generate enhanced API documentation 110 can include providing the machine-learned model 206b with one or more of test case(s) 208, API call(s) 212, API result(s) 216, and API documentation 102, along with in-context learning content (e.g., instruction content, etc.) to cause the machine-learned model 206b to generate enhanced API documentation 110 based on the provided data (e.g., “Based on the following API documentation, API test description(s), and API test result(s), please generate updated API documentation that reflects knowledge learned from the test results.”, etc.).

As another example, in some instances, a machine-learned model 206b can include a model that was trained using training examples generated from documentation data. For example, in some instances, one or more incomplete API documentation examples can be generated by removing a portion of existing API documentation. In some instances, a training example used to train a machine-learned model 206b can include an input-output pair, wherein an output of the input-output pair comprises the removed portion used to generate corresponding incomplete API documentation associated with the training example. In some instances, an input of the input-output pair can include one or more of: the incomplete API documentation; one or more test cases 208, API calls 212, or API results 216 generated based on the incomplete API documentation; or other data.

Additionally or alternatively, in some instances, a machine-learned model 206a, 206b can include a model that was trained using “broken” documentation data configured to “break” a system using an API associated with the broken API documentation (e.g., by causing such a system to generate improper API calls, etc.). In such instances, a training example can include, for example, an input-output example having an input comprising the broken API documentation (e.g., along with other data such as test cases 208, API calls 212, or API results 216 generated based on the broken data, etc.) and an output comprising one or more of a test case 208 generated based on the broken API documentation (e.g., for training a machine-learned model 206a), API documentation (e.g., original, repaired, or unbroken documentation, etc.) used to generate the broken documentation (e.g., for training a machine-learned model 206b), or the like. For example, in some instances, a machine-learned model 206a can include a model configured (e.g., trained, prompted, etc.) to generate one or more unit tests based on API documentation 102.

In some instances, machine-learned model(s) 206b can include one machine-learned model or multiple machine-learned models. For example, in some instances, machine-learned model(s) 206b can include a first machine-learned model 206b configured to analyze an API result 216 (e.g., in relation to a test case 208, etc.) to generate analysis data (e.g., analysis data indicative of information learned from the API result(s) 216, etc.) and a second machine-learned model 206b configured to generate enhanced API documentation 110 based on analysis data generated by the first machine-learned model 206b. In some instances, a first machine-learned model 206b configured to analyze an API result 216 can share one or more properties described below with respect to FIG. 3 and critic(s) 322.

In some instances, a test case 208 or API call 212 can be, comprise, be comprised by, or otherwise share one or more properties with an API call 108. For example, in some instances, a test case 208 or API call 212 can have any property described herein with respect to an API call 108, and vice versa. For example, in some instances, a test case 208 comprising an API call 212 and other content (e.g., test description content, etc.) can be generated by a machine-learned model 206a in any manner described herein with respect to an API call 108, and vice versa. As another example, in some instances, an API call 212 can be used to call an API 214 to generate API results 216 in any manner described herein with respect to an API call 108, and vice versa.

In some instances, a test case 208 can include an API call 212 and additional data (e.g., text data, binary data, sequence data, language data such as natural language data, etc.). In some instances, additional data of a test case 208 can include data describing the test case 208, such as natural language data describing a purpose of the test; an expected API result 216 associated with the test; natural language data describing data that might be learned from the test; data describing a means or strategy for interpreting an API result 216 generated based on the test case 208; or other data.

In some instances, a machine-learned model 206a can generate an API call 212 and other test case 208 content in one output or in multiple separate outputs. For example, in some instances, a machine-learned model 206a can generate a first output comprising an API call 212 and one or more second outputs comprising test description data or other test case 208 data. As another example, in some instances, a machine-learned model 206a can generate a single test case 208 output comprising an API call 212 and other data, and a computing system 104 can parse (e.g., using a regular expression, etc.) the test case 208 to determine (e.g., extract, identify, etc.) an API call 212 of the test case 208.

An application programming interface (API) 214 can include, for example, an interface for interacting with one or more software, firmware, or hardware components associated with the API 214, such as an interface for causing a computing system associated with the API 214 to perform, or an interface for requesting performance of, one or more operations. For example, in some instances, an API 214 can include an interface (e.g., network interface, communication interface, etc.) for providing one or more computer-executable instructions to a software, firmware, or hardware component associated with the API 214. In some instances, an API 214 can include data defining one or more functions (e.g., methods, subroutines, endpoints, etc.) defining a manner in which the API 214 can be called, such as one or more function signatures defining a function name; one or more function parameters; an ordering of the function parameter(s); a syntax for calling the function; or other data defining a manner in which a function of the API 214 can be called. In some instances, an API 214 can include one or more API tools, such as API tools configured to be called by a machine-learned agent to perform various tasks (e.g., tasks requested by a user, etc.).

An API tool can include, for example, any tool (e.g., hardware tool, software tool, firmware tool, etc.) that can be accessed via an API. For example, in some instances, an API tool can include software (e.g., application, operating system, etc.) installed on a computing system 104 or a device (e.g., server device, client device, etc.) running the machine-learned model(s) 206; software available via a network (e.g., internet); hardware devices (e.g., internet-connected hardware devices, Bluetooth-connected hardware devices, etc.); etc. In some instances, a hardware API tool can include a hardware tool connected (e.g., via a network, via a wireless or wired connection, etc.) to a computing system 104 or a device running the machine-learned model(s) 206. In some instances, an API tool can include a navigation API (e.g., map-related API, global positioning system-related API, etc.); a communication API (e.g., API associated with making phone calls, emails, or text messages such as SMS or MMS; APIs associated with communication applications, such as messaging applications, social media communication applications, etc.); a scheduling API (e.g., calendar, alarm, automated task scheduling, etc.); media player API (e.g., video player such as YouTube, audio player, etc.); shopping API; payment API such as Google Pay; mobile banking API; travel-related API (e.g., flight booking, hotel booking, etc.); or API of any application configured to be installed on a mobile device. In some instances, an API tool can include a hardware device such as a Bluetooth-connected lock, gate opener, garage door opener, etc.; an internet-connected doorbell or surveillance camera device; smart home device such as smart TV, smart appliance, lighting devices, thermostats, etc.; or any other API-accessible hardware tool.

In some instances, an API 214 used to generate enhanced API documentation 110 can include a stateless API; an API operating in a test environment or sandbox environment; or other API 214 that can be called without adversely affecting (e.g., without affecting at all, etc.) a state of a production environment. A stateless API can include, for example, an API 214 configured to receive API calls 212 and generate API results 216 based on the API calls 212, without changing a state of the API 214 based on the API call(s) 212 (e.g., without having any side effects; without causing any effects other than outputting the API result(s) 216; etc.).

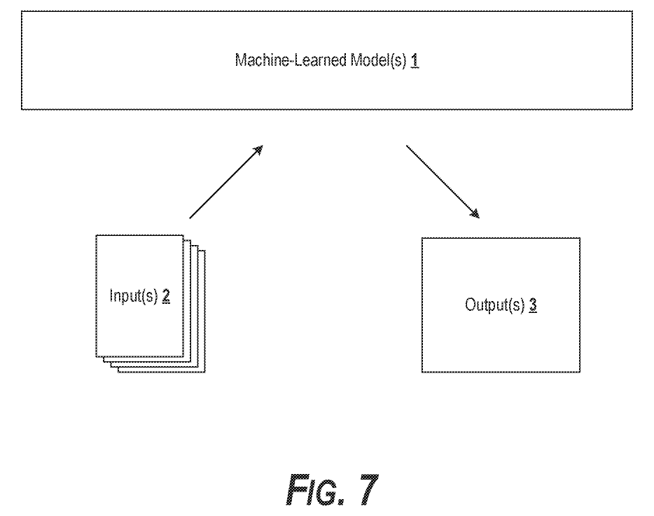

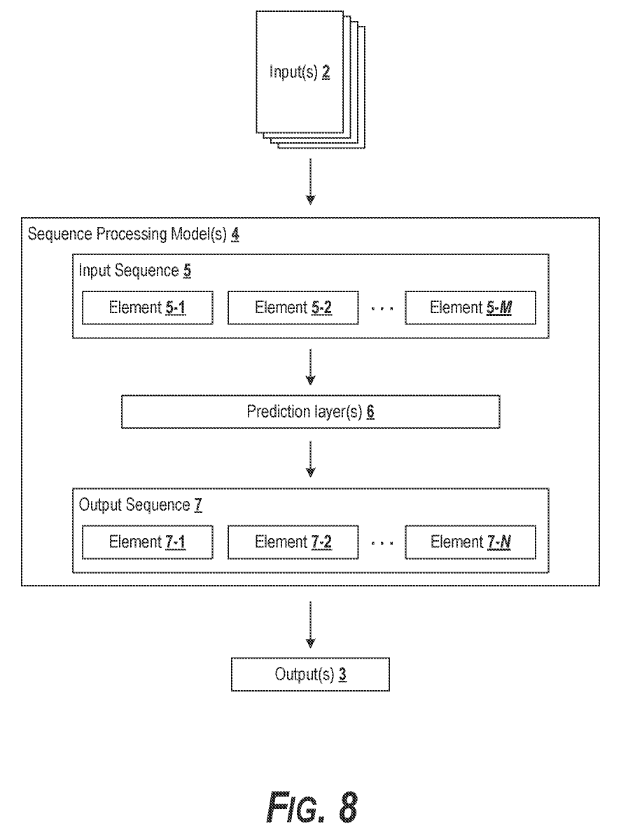

An API result 216 can generally include or otherwise represent various types of data. An API result 216 can include one type or many different types of data. An API result 216 can include one or more data types that are similar to (e.g., same as) or different from one or more data types of API documentation 102, test case(s) 208, or other data described herein. Example data types for an API result 216 can include, for example, any data type output by an API tool described above with respect to an API 214; any data type described below with respect to FIGS. 7-8 and inputs 2 or outputs 3; or other data type.

FIG. 3 is a block diagram illustrating an example system for generating enhanced API documentation 110 based on evaluation(s) 326 of one or more components of an inference process associated with a machine-learned agent 306 according to example implementations of aspects of the present disclosure. A query system 318 can provide one or more queries 320 to a machine-learned agent 306. The machine-learned agent 306 can generate, based at least in part on the one or more queries 320, one or more API calls 108. A computing system can provide the API call(s) 108 to an API 214, which can generate API result(s) 216 based on the API call(s) 108. The computing system can provide the API result(s) 216 to the machine-learned agent 306, which can generate one or more inference outputs 324 based on the API result(s) 216. Additionally, the computing system can provide one or more of the one or more queries 320, API call(s) 108, API result(s) 216, inference output(s) 324 to one or more critics 322, which can output one or more evaluations 326 based on the provided data. Based at least in part on the evaluation(s) 326 (e.g., alone or in combination with other data such as queries 320, etc.), a documentation updater 328 can generate updated API documentation 110.

In some instances, a machine-learned agent 306 can be, comprise, be comprised by, or otherwise share one or more properties with a machine-learned model 106. For example, in some instances, a machine-learned agent 306 can have any property described herein with respect to a machine-learned model 106, and vice versa.

In some instances, a machine-learned agent 306 can include a machine-learned model configured to select an action from an action space. In some instances, an action selected by a machine-learned agent 306 can include an action to be performed by an API. In some instances, a machine-learned agent 306 can include a machine-learned model that has been provided with data indicative of an action space, such as data comprising API documentation 102 or enhanced API documentation 110 defining one or more means for causing an API 214 to perform a selected action (e.g., by outputting an API call 108, etc.). For example, in some instances, the machine-learned agent 306 can be provided with action space data as input context, and the machine-learned agent 306 can select one or more actions based on the input context using in-context learning. As another example, in some instances, the first machine-learned agent 306 can include a machine-learned model that has been trained (e.g., pretrained, fine-tuned, etc.) using data indicative of the action space. In some instances, data indicative of the action space (e.g., data provided via an input context, etc.) can include data associated with one or more tools, such as API documentation 102, 110 data describing a manner of invoking one or more API 214 tools, data listing a plurality of actions that can be performed by one or more API 214 tools, or other data. In some instances, data indicative of the action space (e.g., training data, data provided via an input context, etc.) can include one or more input-output pairs, such as pairs comprising an input context (e.g., user input describing a task to be performed) and a corresponding output value indicative of an action selection (e.g., API call 108 or other action selection output). In some instances, example input-output pairs can be provided as input context to a machine-learned agent 306 according to one or more prompting techniques (e.g., few-shot prompting, chain-of-thought prompting, etc.). In some instances, a machine-learned agent 306 can be trained using example input-output pairs, such as by providing an input of an input-output pair to the machine-learned agent 306; generating, by the machine-learned agent 306 based at least in part on the input, a training output; determining, by a computing system based at least in part on the training output and an objective function (e.g., loss function based on a comparison between the training output and a ground truth output, etc.), one or more parameter updates for the machine-learned agent 306; and updating the machine-learned agent 306 according to the parameter updates.

In some instances, a machine-learned agent 306 can be configured to select actions or perform task planning using various prompting techniques, such as chain-of-thought prompting (e.g., thought-observation-action prompting, etc.), least-to-most prompting, self-critique, or the like. For example, in some instances, a machine-learned agent 306 can be prompted with a plurality of example inputs indicative of a task to be performed, along with a plurality of example reasoning processes for performing the respective tasks. In some instances, each example reasoning process can include a plurality of delimiters configured to mark each part of the example thought process (e.g., “[Thought],” “[Act],” “[Observe]”; “input:”, “tool choice:”, “tool instruction:”; “1” “2” “3”; etc.). An example reasoning process can include, for example, one or more planning components; one or more action selection components; one or more action result components; and one or more output components. In some instances, an example chain-of-thought prompt can include an action selection component comprising one or more API calls 108 for using one or more API 214 tools.

A query system 318 can be or include one or more software, firmware, or hardware components configured to obtain queries 320. In some instances, obtaining queries 320 can include generating queries 320 based on API documentation 102; receiving or retrieving queries 320 (e.g., from a dataset of user-provided queries, etc.); selecting queries 320 from a plurality of available queries (e.g., based on API documentation 102, etc.); or other method of obtaining queries 320. In some instances, the query system 318 can be, comprise, be comprised by, or share one or more properties with a computing device or system described below with respect to FIGS. 13-15 (e.g., computing device 50, third-party system 80, computing device 98, computing device 99, etc.).

In some instances, a query system 318 can include a machine-learned model configured to generate one or more queries 320 based on API documentation 102.

In some instances, a machine-learned model configured to generate one or more queries 320 can include various model architectures, such as various neural network model architectures. An example model architecture for a machine-learned model configured to generate one or more queries 320 can include a sequence processing model architecture (e.g., a transformer model). For example, a machine-learned model configured to generate one or more queries 320 can be configured to receive an input sequence and generate an output sequence. For instance, a machine-learned model configured to generate one or more queries 320 can be configured to generate an output sequence where elements of the output sequence are predicted based on the elements of the input sequence. In some instances, a machine-learned model configured to generate one or more queries 320 can include a model architecture having an attention mechanism (e.g., self-attention). In some instances, a machine-learned model configured to generate one or more queries 320 can be a pre-trained model (e.g., pretrained using large-scale unsupervised learning). In some instances, a machine-learned model configured to generate one or more queries 320 can be fine-tuned over one or more fine-tuning datasets, such as a fine-tuning dataset associated with one or more specialized generation tasks.

In some instances, a machine-learned model configured to generate one or more queries 320 can have any property described herein with respect to a machine-learned model 206. For example, in some instances, a query system 318 can identify data indicative of incompleteness of the API documentation 102 (e.g., in a manner described above with respect to FIG. 2, etc.), and can generate queries 320 based on the data indicative of incompleteness. As another example, in some instances, a query system 318 can include a machine-learned model trained in any manner described above with respect to a machine-learned model 206a, such as using training examples comprising incomplete API documentation data, erroneous API documentation data, or the like. For example, in some instances, a query system 318 can include a machine-learned model that was trained using training examples each comprising one or more input-output pairs, wherein an output of an input-output pair can be a query that can be answered using a first API operation associated with the API 214, and an input of the input-output pair can include incomplete or erroneous documentation data generated by modifying (e.g., removing, editing, etc.) API documentation data associated with the first API operation.

Generating queries 320 can include prompting a machine-learned model of the query system 318 with in-context learning content to cause the machine-learned model to generate targeted queries directed to areas in which API documentation 102 may be incomplete, ambiguous, or the like. For example, in some instances, a machine-learned model of the query system 318 can be provided with instruction content comprising an instruction to generate targeted queries 320; few-shot or chain-of-thought content comprising one or more example input-output tuples comprising API documentation inputs and corresponding query output(s); or other in-context learning content. In some instances, a machine-learned model of the query system 318 can be prompted with one prompt or multiple prompts, such as multiple respective prompts directed to a plurality of respective incompleteness patterns. Example incompleteness patterns can include, for example, function parameters having no identified data type; function parameters having no identified upper or lower bounds; functions having no description data describing the function; operations that may be possible or impossible (e.g., permitted or prohibited, working or broken, etc.), wherein the API documentation data 102 does not specify whether the operation is permitted; function call(s) or function parameter(s) that may be associated with functionality that is not defined by the API documentation 102 (e.g., edge case associated with a boundary between defined behaviors, etc.), or function call(s) associated with a range of possible behavior(s) (e.g., functions for which an API definition is ambiguous or otherwise fails to completely define an expected behavior of the function, etc.); possible boundary conditions for which behavior of an API 214 is not expressly defined; or other incompleteness pattern.

In some instances, API documentation 102 can include documentation associated with a plurality of APIs 214, and generating queries 320 can include prompting a machine-learned model of the query system 318 with in-context learning content to cause the machine-learned model to generate targeted queries directed to a decision boundary between a first API and second API. For example, in some instances, a machine-learned model of the query system 318 can be prompted with an instruction to identify one or more API 214 operations for which two or more APIs 214 might be suitable, and generate one or more queries 320 based on the operation(s).

In some instances, a query system 318 can generate context-specific queries 320 associated with a particular context, such as a set of queries 320 associated with a common topic; a set of queries 320 generated based on a particular user, group of users, setting, purpose, activity or group of activities, or the like; or other context-specific query 320 set. In some instances, a machine-learned model of the query system 318 can be prompted with in-context learning content associated with a context of interest, such as a context in which a machine-learned agent is expected to be used in a production environment (e.g., production environment as described below with respect to FIG. 4, etc.).

Additionally or alternatively, in some instances, a query system 318 can provide API documentation 102 to a machine-learned model configured (e.g., fine-tuned; prompted with instruction content, chain-of-thought content, etc.; or the like) to generate a set of queries 320 (e.g., natural language queries, etc.) configured to cause a machine-learned agent to generate a broad range of API calls in responding to the queries, such as a range of API calls that may include most (e.g., all, etc.) of a set of available API functions (e.g., with or without regard to any areas of incompleteness in the API documentation 102, etc.).

Additionally or alternatively, in some instances, the query system 318 can include a retrieval system configured to retrieve one or more queries 320. For example, in some instances, the query system 318 can include a data structure (e.g., database such as relational database, NoSQL database, vector database, etc.; file, folder, object, struct, or other data structure; etc.) comprising one or more stored queries 320, such as queries 320 received from one or more users; queries 320 generated by one or more machine-learned models; or other queries 320. For example, in some instances, retrieving queries 320 can include generating one or more machine-learned embedding vectors based on API documentation 102 (e.g., by providing all or part of the API documentation 102 to a machine-learned embedding model, etc.), and retrieving a plurality of queries 320 (e.g., k nearest neighbor queries 320, etc.) based on a metric of similarity between vector embeddings of the queries 320 and embedding vector(s) generated based on the API documentation 102. For example, in some instances, a metric of similarity can include a metric of distance, such as cosine distance, Euclidean distance, or other distance metric. Other implementations are possible.

A query 320 can include, for example, an input directed to a machine-learned agent 306. In some instances, a query 320 can include an input configured to cause the machine-learned agent 306 to generate one or more API calls 108 based on the query 320, and generate one or more inference outputs 324 based on one or more API results 216 received based on the API call(s) 108. In some instances, a query 320 can include data (e.g., text data, natural language data, speech data, etc.) indicative of one or more tasks to be performed, such as tasks comprising a combination of one or more API 214 operations and one or more machine-learned inference operations; tasks comprising a requested inference operation to be performed using one or more API results 216; or the like.

The critic(s) 322 can include, for example, one or more machine-learned models configured (e.g., trained, prompted, etc.) to evaluate one or more aspects of a response trajectory of a machine-learned agent 306 in responding to a query 320. For example, in some instances, a critic(s) 322 can include one or more of a code critic 322a configured to evaluate one or more API calls 108 (e.g., based on a comparison between the API call(s) 108 and a query 320 associated with the API call(s) 108, etc.); an API result critic 322b configured to evaluate one or more API results 216 (e.g., based on a comparison between the API result(s) 216 and a query 320 associated with the API result(s) 216, etc.); an inference output critic 322c configured to evaluate one or more inference outputs 324 (e.g., based on a comparison between the inference output(s) 324 and a query 320 associated with the inference output(s) 324, etc.); or other critics 322d.

The critic(s) 322 can include one or more machine-learned models. The critic(s) 322 can include various model architectures, such as various neural network model architectures. An example model architecture for a critic 322 can include a sequence processing model architecture (e.g., a transformer model). For example, the critic(s) 322 can be configured to receive an input sequence and generate an output sequence. As another example, in some instances, a critic 322 can be configured to receive an input sequence and generate a non-sequence output (e.g., numerical score output, binary classification output, etc.) based on the input. In some instances, a critic 322 can include a model architecture having an attention mechanism (e.g., self-attention). In some instances, 1 critic 322 can be a pre-trained model (e.g., pretrained using large-scale unsupervised learning). In some instances, the critic 322 can be fine-tuned over one or more fine-tuning datasets, such as a fine-tuning dataset associated with one or more specialized generation tasks.

In some instances, a critic 322 can include a machine-learned model that has been provided (e.g., prompted, etc.) with in-context learning content to cause the critic 322 to evaluate one or more aspects of a response trajectory of a machine-learned agent 306. For example, in some instances, a code critic 322a can be prompted with an instruction to compare an input API call 108 to an input query 320, and to identify any possible mismatch between the API call 108 and the query 320. In some instances, a code critic 322a can be provided with one or more few-shot examples or chain-of-thought examples, such as examples indicative of one or more error patterns. Example error patterns can include, for example, parameters of an API call 108 that are not requested by any aspect of a query 320 (e.g., extra parameters, phantom parameters, erroneous parameters, etc.); details of a query that are not reflected in the API call 108 (e.g., missing parameters, erroneous parameters, etc.); syntax errors; irrelevant or unwanted API 214 operations that are not requested by or responsive to a query 320; or other error pattern. In some instances, a set of critic(s) 322 can include zero code critics 322a, one code critic 322a, or multiple code critics 322a (e.g., plurality of respective code critics 322a associated with a plurality of respective error patterns, etc.). In some instances, a code critic 322a can be further prompted with in-context learning content (e.g., instruction content, few-shot example content, etc.) to cause the code critic 322a to evaluate an API call 108 based on a comparison to the API documentation 102, such as in-context learning indicative of one or more error patterns (e.g., syntax error patterns, erroneous argument pattern, etc.).

As another example, in some instances, an API result critic 322b can be provided with in-context learning content (e.g., instruction content, etc.) to cause the API result critic 322b to compare an API result 216 to a query 320 and evaluate whether the API result 216 contain sufficient information to satisfy the query 320; whether the API result 216 is responsive to the query 320; whether the API result 216 matches one or more ground truth result values; or other evaluation. In some instances, an API result critic 322b can be provided with one or more few-shot or chain-of-thought examples, such as examples indicative of one or more successful operations (e.g., indicative of complete, responsive API result 216 data, etc.) or examples indicative of one or more error patterns, incompleteness patterns, or the like. Example error patterns or incompleteness patterns can include, for example, API results 216 that are unresponsive to or unrelated to a query 320; API results 216 having missing information, such as API results 216 that are responsive to a first part of a query 320 but not responsive to a second part of the query 320; API results 216 having incorrect information or information directed to content that is unrelated to a query 320; or other error pattern. In some instances, a set of critic(s) 322 can include zero API result critics 322b, one API result critic 322b, or multiple API result critics 322b (e.g., plurality of respective API result critics 322b associated with a plurality of respective error patterns, etc.).

As another example, in some instances, an inference output critic 322c can be provided with an instruction to compare an inference output 324 to a query 320 and evaluate whether the inference output 324 satisfies every element of the query (e.g., whether any data requested by the query is omitted from the inference output; whether any part of the inference output violates a requested constraint associated with the query; etc.); whether the inference output 324 contains any additional or irrelevant information not requested by the query; whether the inference output 324 matches one or more ground truth output values; or other evaluation content. In some instances, an inference output critic 322c can be provided with one or more few-shot or chain-of-thought examples, such as examples indicative of one or more successful operations (e.g., indicative of accurate or query-compliant inference outputs 324, etc.) or examples indicative of one or more error patterns. Example error patterns can include omission of data requested by a query 320; inclusion of irrelevant or unresponsive data not requested by a query 320; inclusion of inaccurate or erroneous data (e.g., based on comparison to a ground-truth output value, etc.); violation of one or more constraints requested by a query 320; or other error pattern. In some instances, a set of critic(s) 322 can include zero inference output critics 322c, one inference output critic 322c, or multiple inference output critics 322c (e.g., plurality of respective inference output critics 322c associated with a plurality of respective error patterns, etc.).

In some instances, an API result critic 322b or inference output critic 322c can be provided with in-context learning content (e.g., instructions, few-shot or chain-of-thought examples, etc.) to cause the critic 322 to identify one or more constraints associated with each of one or more elements of an API result 216 or inference output 324, and generate a separate evaluation 326 for each constraint. As a non-limiting illustrative example, if a query asked to return all vegetarian restaurants within a 5-mile radius of a cited location, a critic 322 can identify whether each return value associated with an API result 216 is (1) a restaurant, (2) vegetarian, or (3) within the 5-mile radius. More generally, a critic 322 can include a critic 322 configured (e.g., prompted, etc.) to identify, based on a query 320 (e.g., alone or in combination with other data such as API documentation 102, etc.) one or more expectations associated with an API call 108, API result 216, or inference output 324 generated based on the query; and evaluate, for each of the one or more expectations, whether the expectation was met (e.g., by generating an evaluation score indicative of a degree to which the expectation was met, etc.). In some instances, constraints or expectations can include “soft” constraints, “hard” constraints, or both. For example, in some instances, a critic 322 can be configured (e.g., trained, prompted, etc.) to identify one or more hard or soft constraints; reduce an evaluation score to a minimum value (e.g., zero, etc.) if a hard constraint is violated; and reduce an evaluation score by a different amount (e.g., according to a penalty structure, loss function, or the like) if a soft constraint is violated. As another example, in some instances, a critic 322 can be configured to output non-numerical evaluation 326 data, such as Boolean data (e.g., Boolean data indicative of an unacceptable output if a hard constrained is violated, etc.); natural language data (e.g., natural language data explaining which hard or soft constraints are violated or complied with by an API result 216, inference output 324, or other data, etc.); or other data type.

As another example, in some instances, an other critic 322d can include a critic 322 configured to generate evaluations 326 based on other data. In some instances, an other critic 322d can include a critic configured to evaluate a query 320, such as a critic provided with an instruction to evaluate a currentness of the query 320 (e.g., based on a date or time the query 320 was generated; based on a machine-learned estimate of a shelf life of the query 320; etc.) (e.g., “Based on how frequently data asked about in the following query is likely to change, and based on the following creation date and current date, please rate how up to date the following query is on a scale of 1 to 10”, etc.).

Additionally or alternatively, in some instances, one or more critics 322 can include critic(s) 322 that have been trained (e.g., fine-tuned, etc.) using training examples indicative of high-quality or low-quality response trajectories of a machine-learned agent 306. For example, in some instances, a training example can include an example query 320; one or more ground truth correct (e.g., suitable, acceptable, responsive to a query 320, etc.) values (e.g., API calls 108, inference outputs 324, API results 216, etc.); one or more example erroneous (e.g., incorrect, inaccurate, unsuitable, irrelevant or unresponsive to a query 320, etc.) values; ground truth evaluation values (e.g., evaluation scores, natural language evaluation content, etc.); or other training example content. For example, in some instances, a training example for training a code critic 322a can include a training input comprising an example query and corresponding example API call (e.g., erroneous API call, correct API call, etc.); and a training output comprising a ground truth evaluation (e.g., numerical score, Boolean yes/no evaluation, natural language evaluation, etc.) of the example API call in relation to the example query. Similarly, other critics 322 can be trained using training examples comprising other example inputs (e.g., example API result 216 inputs, example inference output 324 inputs, etc.) and corresponding ground truth evaluations in relation to a corresponding query. In some instances, a loss function for training a critic 322 based on natural language ground truth outputs can include a loss function based at least in part on a metric of similarity (e.g., metric of distance in a shared machine-learned embedding space, such as cosine distance or Euclidean distance, etc.) between a first embedding of a ground truth evaluation and a second embedding of a training output generated by the critic 322 being trained.

An inference output 324 can generally include or otherwise represent various types of data. An inference output 324 can include one type or many different types of data. An inference output 324 can include one or more data types that are the same as or different from a data type of a query 320 or other data. Example data types for an inference output 324 can include, for example, any data type described below with respect to FIGS. 7-8 and inputs 2, such as language data (e.g., natural language data such as text or speech data, programming language data, etc.), sequence data (e.g., language sequence, time series, etc.), image data, audio data, video data, or another data type. In some instances, an inference output 324 can include or be included in data indicative of a reasoning chain performed by the machine-learned agent 306, such as data indicative of one or more intermediate reasoning steps; data indicative of one or more actions selected by the machine-learned agent 306, such as one or more API calls 108; and data indicative of a response (e.g., final response, etc.) to the query 320 based on one or more API results 216 (e.g., alone or in combination with other data, etc.). In some instances, an inference output 324 can include a response to a query 320, in combination with one or more delimiters associated with a reasoning chain of the machine-learned agent 306 (e.g., “[Thought],” “[Act],” “[Observe]”; “query:”, “API choice:”, “API instruction:”; “1” “2” “3”; etc.). In some instances, a sequence output by the machine-learned agent 306 can be parsed (e.g., based on one or more delimiters; using a regular expression; etc.) and an inference output 324 (e.g., final response to a query 320, etc.) can be extracted based on the parsing.

An evaluation 326 can include, for example, any data output by a critic 322 that is evaluative of other content (e.g., API call(s) 108, API result(s) 216, inference output(s) 324, etc.) generated based on a query 320, such as evaluation score data; natural language data such as description data; structured data such as JSON-structured evaluation 326 comprising a plurality of evaluation values; or other evaluation content. An evaluation 326 can generally include or otherwise represent various types of data. An evaluation 326 can include one type or many different types of data. Example data types for an evaluation 326 can include, for example, numerical evaluation data (e.g., evaluation scores, etc.); Boolean evaluation data (e.g., yes/no, good/bad, binary classifier output such as entailment indicator, etc.); language data (e.g., natural language description of an identified error pattern, etc.); structured evaluation data (e.g., JSON or XML data, etc.); output tokens (e.g., natural language tokens; tokens of a sequence; specialized tokens indicative of a rating; etc.); binary data; or other data type.

In some instances, an evaluation 326 can include evaluation data evaluating an entire API call 108, inference output 324, API result 216, or other content; evaluation data evaluating only a portion of the API call 108, inference output 324, API result 216, or other content being evaluated; or both. For example, in some instances, a query 320 can define a plurality of constraints (e.g., “Please identify all vegetarian restaurants within a 5-mile radius of 555 Main St.”, etc.), and an evaluation 326 or set of evaluations 326 can include evaluation content associated with each constraint (e.g., “result 1: Vegetarian? Yes; Restaurant? Yes; Within 5 miles of 555 Main St.? No” etc.). As another example, in some instances, an API call 108, inference output 324, or other data can include sequence data comprising a plurality of tokens, and evaluations 326 can include full-sequence evaluation data (e.g., scores, classifications, natural language evaluation, etc.) associated with an entire sequence; single-token evaluation data or other subsequence evaluation data; or both.

In some instances, a documentation updater 328 can be, comprise, be comprised by, or otherwise share one or more properties with a machine-learned model 106, 206b. For example, in some instances, a documentation updater 328 can have any property described herein with respect to a machine-learned model 106, 206b, and vice versa. In some instances, a documentation updater 328 can include a machine-learned model configured (e.g., trained, prompted, etc.) to receive evaluations 326 (e.g., alone or in combination with other data such as queries 320, API documentation 102, test case 208 data such as test description content, etc.) and generate enhanced API documentation 110 based on the evaluations 326. For example, in some instances, a documentation updater 328 can receive natural language evaluations 326 describing one or more error patterns, and can generate enhanced API documentation 110 to reduce a likelihood of generating the error patterns. As another example, in some instances, a documentation updater 328 can receive a plurality of evaluation scores associated with a plurality of API calls 108 or other content, and can generate enhanced API documentation 110 to increase (e.g., increase relative to a system using API documentation 102, etc.) a likelihood of generating higher-scoring API calls 108 or reduce a likelihood of generating lower-scoring API calls 108. For example in some instances, a documentation updater 328 can receive evaluations 326 associated with API calls 108 to a plurality of APIs 214, and the documentation updater 218 can generate enhanced API documentation 110 to increase a likelihood of selecting the best (e.g., highest-scoring according to evaluations 326, etc.) API 214 for a given context based on the evaluations 326. For example, in some instances, a documentation updater 328 can be prompted with an instruction to add natural language content explaining when (e.g., for what types or categories of queries 320, etc.) a first API 214 should be called, and when a second API 214 should be called. In some instances, a document updater 328 can obtain API documentation 102 associated with a plurality of APIs 216 (e.g., a separate API documentation 102 document for each API; one or more combined API documentation 102 documents comprising documentation data for a plurality of APIs; etc.), and can generate combined documentation data (e.g., combined enhanced API documentation 110, etc.) based on one or more of the API documentation 102, evaluations 326, and other data (e.g., API calls 108, inference outputs 324, API results 216, etc.).

Additionally or alternatively, in some instances, a documentation updater 328 can include one or more non-machine-learned components, such as a component configured to receive a plurality of API calls 108 and corresponding API results 216 and identify, based on the results 216, an upper or lower bound of one or more parameters; or other non-machine-learned components.

In some instances, a plurality of candidate enhanced API documentation 110 examples (e.g., candidate updates, edits, additions such as documentation snippets to be added; candidate full-document enhanced API documentation 110; etc.) can be generated, and a consolidated enhanced API documentation 110 document can be generated based on the candidate documentation examples. For example, in some instances, a plurality of candidate edits to the API documentation 102 can be generated, and the plurality of edits can be consolidated into a single enhanced API documentation 110 document.

In some instances, consolidating a plurality of candidate edits into consolidated enhanced API documentation 110 can be performed by including all of the plurality of candidate edits in the enhanced API documentation 110, or by selecting a subset of candidate edits to include. For example, in some instances, a plurality of candidate edits can be scored according to one or more criteria, such as verbosity, testing outcomes, or other criteria. For example, in some instances, a plurality of candidate enhanced API documentation 110 examples (e.g., candidate edits, candidate additions, candidate full-document examples, etc.) can be scored according to a metric of verbosity (e.g., length, character count, word count, token count, memory footprint in bytes, etc.), and one or more candidate enhanced API documentation 110 examples can be selected (e.g., edits selected for inclusion in consolidated enhanced API documentation 110, etc.) based on the scores. In some instances, the plurality of candidate enhanced API documentation 110 examples can be scored according to one or more other criteria, such as according to one or more tests. For example, in some instances, a machine-learned agent 306 can respond to a plurality of queries 320 (e.g., queries 320 of a fixed benchmark, example queries 320 of a training dataset, etc.) based on one or more of a plurality of candidate enhanced API documentation 110 examples, and each of the plurality of candidate enhanced API documentation 110 examples can be scored based on one or more outputs of the machine-learned agent (e.g., based on an objective function, ground truth label(s), or the like; based on one or more evaluations 326 generated by one or more critics 322; or other scoring process). In some instances, candidate enhanced API documentation 110 examples can be selected (e.g., candidate edits for inclusion in consolidated enhanced API documentation 110, etc.) based on one or more scoring values associated with the candidate examples, such as based on a tradeoff between verbosity and testing outcomes. For example, in some instances, a plurality of candidate edits can be selected based on a maximum length limit for the enhanced documentation 110, such as by selecting a set of candidate edits that maximize or nearly maximize (e.g., approximately maximize according to a heuristic, etc.) an expected testing score given the maximum length limit. As another example, in some instances, a plurality of candidate edits can be selected according to a tradeoff heuristic, such as a threshold ratio between an improvement in testing scores attributable to the candidate edit and a corresponding increase in length attributable to the candidate edit.

In some instances, a plurality of candidate enhanced API documentation 110 examples (e.g., candidate edits, candidate full-document examples, etc.) can be narrowed down according to a multi-step process, such as by scoring a large plurality of candidate examples according to a lightweight scoring function (e.g., function comprising an arithmetic combination of one or more already-computed or easy-to-compute values, such as length of the candidate edit, already-computed evaluations 326, or the like) and filtering based on score; evaluating a smaller plurality of candidate examples according to a more computationally complex automated process (e.g., creating new evaluations 326 using critics 322, entailment classifier(s), etc.), and further filtering; and evaluating a short list of candidate examples using human feedback. Other implementations are possible.

FIG. 4 is a block diagram illustrating an example system for performing actions using a machine-learned agent based on enhanced API documentation according to example implementations of aspects of the present disclosure. A machine-learned agent 406 can receive enhanced API documentation 110 and one or more queries 420. Based on the enhanced API documentation 110 and one or more queries 420, the machine-learned agent 406 can provide one or more API calls 408 to an API 214, and can receive one or more API results 416 responsive to the call(s) 408. Based at least in part on the API result(s) 416, the machine-learned agent 406 can generate one or more inference outputs 424.

In some instances, a machine-learned agent 406 can be, comprise, be comprised by, or otherwise share one or more properties with a machine-learned agent 306. For example, in some instances, a machine-learned agent 406 can have any property described herein with respect to a machine-learned agent 306, and vice versa. In some instances, a machine-learned agent 406 can include a model that is the same as or different from a machine-learned agent 306 used to generate, test, select, or otherwise determine enhanced API documentation 110 provided to the machine-learned agent 406 in responding to a query 420. For example, in some instances, determining enhanced API documentation 110 using the same machine-learned agent 406 that will be used in production to respond to one or more user queries 420 can provide improved technical performance (e.g., inference accuracy, API call 408 quality, API call 408 error rate, etc.) compared to using a different machine-learned agent 306, whereas using a single machine-learned agent 306 to generate enhanced API documentation 110 to be used by a plurality of different machine-learned agents 406 can reduce a computational cost of generating enhanced API documentation 110 compared to using each machine-learned agent 406 to generate model-specific enhanced API documentation 110.

In some instances, an API call 408 can be, comprise, be comprised by, or otherwise share one or more properties with an API call 108. For example, in some instances, an API call 408 can have any property described herein with respect to an API call 108, and vice versa. In some instances, an API call 408 can include an API call generated based at least in part on enhanced API documentation 110.

In some instances, a query 420 can be, comprise, be comprised by, or otherwise share one or more properties with a query 320. For example, in some instances, a query 420 can have any property described herein with respect to a query 320, and vice versa. In some instances, a query 420 can include a query 420 provided by a user, such as a request to perform one or more actions (e.g., inference actions, API tool actions, digital assistant actions, etc.) using one or more APIs 214.

In some instances, an inference output 424 can be, comprise, be comprised by, or otherwise share one or more properties with an inference output 324. For example, in some instances, an inference output 424 can have any property described herein with respect to an inference output 324, and vice versa. In some instances, an inference output 424 can include an inference output 424 provided to a user in response to a user query 420.

More generally, any operation or component (e.g., critic 322, API call 108, etc.) depicted in connection with an operation to generate enhanced API documentation 110 (e.g., as described herein with respect to FIG. 3) can be used in a similar (e.g., same) manner with respect to an operation to respond to a query 420 (e.g., user query, etc.) in an environment (e.g., production environment, etc.) depicted in FIG. 4. For example, in some instances, first enhanced API documentation 110 can be generated based on one or more of: queries 320 (e.g., queries 320 received from users, generated automatically, etc.); API calls 108 generated by a first machine-learned agent 306 based on the queries 320; API results 216 received from one or more APIs 214 based on the API calls 108; inference outputs 324 generated by the first machine-learned agent 306 based on the API results 216; or other data. Continuing the example, in some instances, the first enhanced API documentation 110 can be provided, in a production environment, to the first machine-learned agent 306 or a second machine-learned agent 406 to enable the machine-learned agent 306, 406 to respond to queries 420 (e.g., newly received user queries 420; retrieved or generated queries 320, 420; etc.) based on the enhanced API documentation 110. In this manner, for instance, enhanced API documentation 110 according to some aspects of the present disclosure can improve a technical performance (e.g., inference quality, inference accuracy, computational cost, etc.) of the machine-learned agent 406 compared to some alternative implementations.

In some instances, enhanced API documentation 110 can be used to generate API calls 408 that may include improved API calls compared to some API calls 108 generated with first API documentation 102. For example, in some instances, enhanced API documentation 110 can include data indicative of one or more requirements (e.g., valid or invalid parameter values; valid or invalid device states from which an API function can be called; etc.) for calling the API, such as new requirements data that is not included in the first API documentation 102. Continuing the example, in some instances, providing the enhanced API documentation 110 to a machine-learned agent 406 can cause the machine-learned agent 406 to generate API calls 408 that comply with the one or more requirements, or otherwise increase a likelihood of generating valid API calls 408. In some instances, the one or more requirements can include requirements that, when violated, may cause an API or hardware device associated with the API to encounter an exception or error (e.g., throw a memory out-of-range exception; return an error message or other error value, such as a NULL return value, etc.; or otherwise encounter an exception or error).

As a non-limiting illustrative example, in some instances, API documentation 102 can include enhanced API documentation 102 associated with one or more APIs 214 for controlling one or more smart home devices (e.g., doors such as garage doors; audiovisual devices such as televisions or speakers; cleaning devices such as robotic vacuums or mops, dishwashers, laundry washer/dryer devices; interior or exterior lighting devices; cooking devices such as ranges, ovens, microwaves, air fryers, coffee machines, toasters, or the like; thermostats; fans; humidifiers, air purifiers, or other air quality devices; smart refrigerators; security camera or alarm devices; smart doorbells; smart electrical outlets; or other smart home device). Enhanced API documentation 110 can include, for example, first documentation 102 data and additional data, such as data (e.g., natural language data, text data, structured data such as JSON-structured data, etc.) describing one or more requirements for calling one or more functions of the one or more APIs 214. For example, in some instances, a requirement can include one or more minimum or maximum numerical values for a numerical parameter of an API 214 function, such as a minimum or maximum temperature value for a function setting one or more temperatures associated with a smart home device (e.g., thermostat, oven, dryer, etc.); a minimum or maximum time value (e.g., duration of a function to be performed, time delay before starting execution of an API function, date/time value for starting execution of an API 214 function, etc.); a minimum or maximum value indicative of a memory location (e.g., array index value, etc.); a minimum or maximum numerical setting of a smart home device (e.g., volume setting, brightness setting, etc.); or other minimum or maximum numerical value. In some instances, a requirement can include data indicative of a set of valid values for a parameter (e.g., non-numerical or numerical parameter, etc.), such as a list of valid values (e.g., “low,” “medium,” “high,” etc.), data indicative of a condition separating valid from invalid values (e.g., “this parameter must be a positive integer,” etc.), or the like. In some instances, a requirement can include data indicative of a set of device states (e.g., activated/deactivated states such as on/off, armed/disarmed, standby/running, locked/unlocked, connected/disconnected, open/closed etc.; operational modes such as Eco mode, fan-only mode, heat/cool mode, or the like; location states such as first floor, second floor, etc.; other states such as full/empty/needs refill, stuck, needs software update, etc.) in which a function can be performed or in which a parameter value is valid. In some instances, the one or more requirements can include requirements that, when violated, may cause an API or hardware device associated with the API to encounter an exception or error (e.g., throw an out-of-range exception; return an error message or other error value, such as an invalid-device-state error message; etc.).

In some instances, providing a machine-learned agent 406 with enhanced API documentation 110 comprising data indicative of one or more API instruction requirements (e.g., parameter requirements, device state requirements, etc.) and a query 420 can cause the machine-learned agent 406 to generate a valid API call 408 that meets the one or more API instruction requirements. In some instances, an API call 408 (e.g., valid API call 408, etc.) generated based on enhanced API documentation 110 can be provided to an API 214 (e.g., digital assistant API, smart home API, etc.), such as an API 214 configured to control one or more hardware devices (e.g., smart home device, self-driving vehicle, robotic manufacturing device, etc.) based on the API call 408. For example, in some instances, an API call 408 can include an instruction to activate or deactivate a hardware device (e.g., smart home device, etc.) such as an instruction to start or stop an operational cycle of a hardware device (e.g., washer/dryer, robotic vacuum, etc.); arm or disarm a security system; turn a device (e.g., smart lights, smart plug, etc.) on or off; or otherwise activate or deactivate a hardware device. As another example, in some instances, an API call 408 can include an instruction to open or close a hardware device (e.g., smart door such as garage door, smart window blinds or window curtains, etc.) or component thereof (e.g., valve, dispensing aperture, etc.). As another example, in some instances, an API call 408 can include an instruction selecting one or more inputs (e.g., television channel, input device such as HDMI port, uniform resource locator (URL) such as video streaming or audio streaming URL, radio station, or other input) of a plurality of inputs associated with a hardware device.

In some instances, API calls 408 generated using enhanced API documentation 110 may include API calls 408 that may be better aligned with a query 420 compared to API calls 408 generated using first API documentation 102. For example, in some instances, a query 420 can include data (e.g., natural language data, text data, speech data, etc.) indicative of one or more requested actions or data indicative of one or more properties of one or more requested actions. In some instances, enhanced API documentation 110 can include data (e.g., data not included in the first API documentation 102, etc.) indicative of one or more API 214 functions, API 214 parameters, or API 214 parameter settings for performing the requested action(s) or complying with the one or more requested properties (e.g., data generated using one or more critics 322 as described herein with respect to FIG. 3, etc.). In some instances, providing a machine-learned agent 406 with enhanced API documentation 110 comprising data for performing the requested action(s) can cause (or increase a likelihood of causing, etc.) the machine-learned agent 406 to generate API calls 408 to cause the API 214 to perform the requested action(s). In this manner, for instance, enhanced API documentation 110 can be used to perform API 214 operations or generate inference output(s) 424 that may better align with a query 420 compared to first API documentation 102.In some instances, enhanced API documentation 110 can include additional data that is not included in the first API documentation 102, such as additional data generated (e.g., according to methods described in FIGS. 2-3, etc.) based on one or more incompleteness patterns associated with the first API documentation 102. Example incompleteness patterns can include, for example, function parameters having no identified data type; function parameters having no identified upper or lower bounds; functions having no description data describing the function; operations that may be possible or impossible (e.g., permitted or prohibited, working or broken, etc.), wherein the API documentation data 102 does not specify whether the operation is permitted; function call(s) or function parameter(s) that may be associated with functionality that is not defined by the API documentation 102 (e.g., edge case associated with a boundary between defined behaviors, etc.), or function call(s) associated with a range of possible behavior(s) (e.g., functions for which an API definition is ambiguous or otherwise fails to completely define an expected behavior of the function, etc.); possible boundary conditions for which behavior of an API 214 is not expressly defined; or other incompleteness pattern.

In some instances, additional data generated according to an incompleteness pattern can help a machine-learned agent 406 to avoid one or more errors associated with the incompleteness pattern. For example, in instances where first API documentation 102 lists function parameter(s) having no identified data type, enhanced API documentation 110 can include data type identifier(s) for the function parameter(s), thereby helping the machine-learned agent 406 to generate valid API calls 408 comprising valid data type(s) for the function parameter(s), and to avoid invalid data type errors. Similarly, in instances where first API documentation 102 lists function parameter(s) without identifying upper or lower bounds for the function parameter(s), enhanced API documentation 110 can include upper or lower bound data, and providing the enhanced API documentation 110 to the machine-learned agent 406 can decrease a likelihood of generating an invalid API call 408 comprising function parameter value(s) above an upper bound or below a lower bound. In instances wherein first API documentation 102 lacks data indicating one or more circumstances in which an operation may be impermissible (e.g., impossible, inaccessible, etc.), enhanced API documentation 110 may include such data, thereby reducing a likelihood of generating an invalid API call 408 calling an impermissible operation. In instances where first API documentation 102 does not completely or unambiguously define a function’s behavior (e.g., due to boundary conditions, due to ambiguity of the first API documentation 102, etc.), enhanced API documentation 110 can include data further defining the function’s behavior, and providing the enhanced API documentation 110 to the machine-learned agent 406 can increase a likelihood of generating an API call 408 causing behavior that complies with a query 420 (e.g., compared to providing first API documentation 102 to the machine-learned agent 406, etc.).

### Example Methods

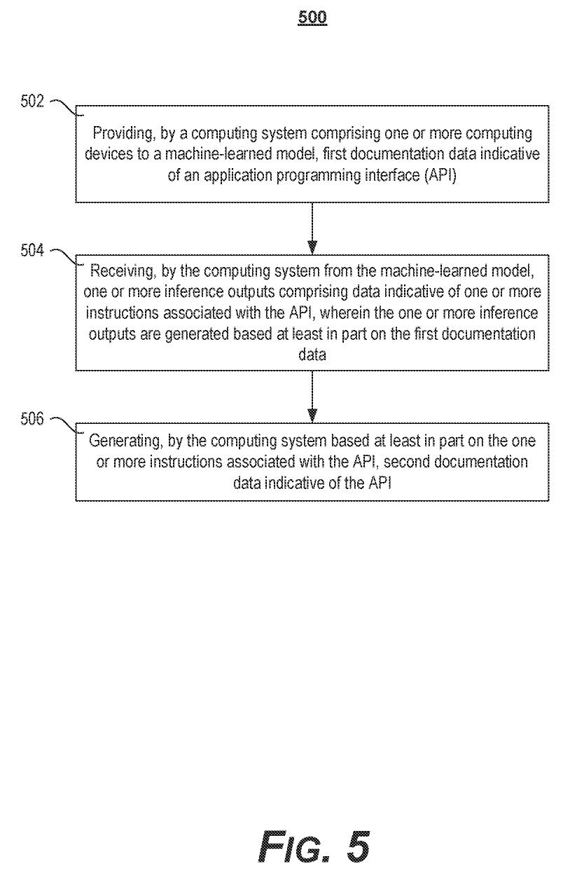

FIG. 5 depicts a flowchart diagram of an example method for improving API documentation according to example embodiments of the present disclosure. Although FIG. 5 depicts steps performed in a particular order for purposes of illustration and discussion, the methods of the present disclosure are not limited to the particularly illustrated order or arrangement. The various steps of example method 500 can be omitted, rearranged, combined, and/or adapted in various ways without deviating from the scope of the present disclosure.

At 502, example method 500 can include providing, by a computing system (e.g., computing system 104, etc.) comprising one or more computing devices to a machine-learned model (e.g., machine-learned model 106, 206; machine-learned agent 306, 406; etc.), first documentation data (e.g., API documentation 102, etc.) indicative of an application programming interface (API) (e.g., API 214, etc.). In some instances, example method 500 at 502 can include using one or more systems or performing one or more activities described with respect to FIGS. 1-3.

At 504, example method 500 can include receiving, by the computing system from the machine-learned model, one or more inference outputs (e.g., API calls 108, test cases 208, etc.) comprising data indicative of one or more instructions (e.g., API calls 108, 212, etc.) associated with the API, wherein the one or more inference outputs are generated based at least in part on the first documentation data. In some instances, example method 500 at 504 can include using one or more systems or performing one or more activities described with respect to FIGS. 1-3.

At 506, example method 500 can include updating, by the computing system based at least in part on the one or more instructions, the first documentation data (e.g., to generate updated documentation data 110, etc.). In some instances, example method 500 at 506 can include using one or more systems or performing one or more activities described with respect to FIGS. 1-3.

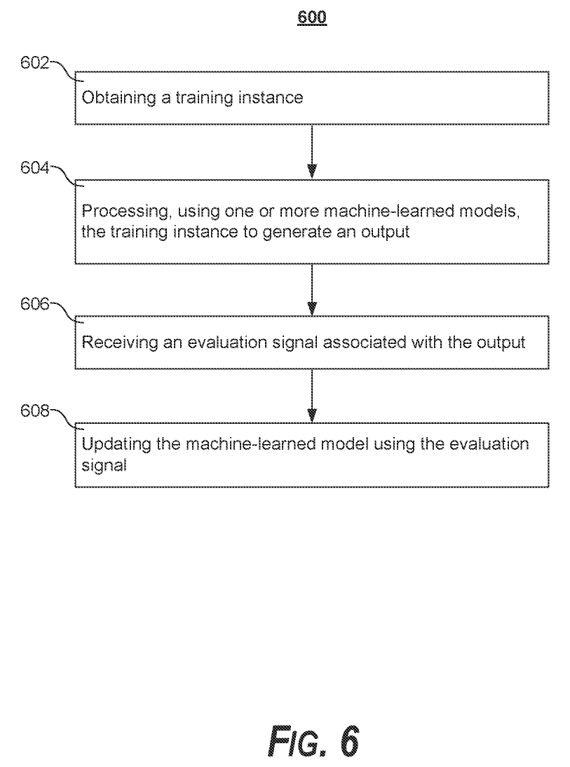

FIG. 6 depicts a flowchart of a method 600 for training one or more machine-learned models according to aspects of the present disclosure. For instance, an example machine-learned model can include a machine-learned model 106, 206 or machine-learned agent 306, 406.

One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

At 602, example method 600 can include obtaining a training instance. A set of training data can include a plurality of training instances divided between multiple datasets (e.g., a training dataset, a validation dataset, or testing dataset). A training instance can be labeled or unlabeled. Although referred to in example method 600 as a “training” instance, it is to be understood that runtime inferences can form training instances when a model is trained using an evaluation of the model’s performance on that runtime instance (e.g., online training/learning). Example data types for the training instance and various tasks associated therewith are described throughout the present disclosure.

At 604, example method 600 can include processing, using one or more machine-learned models, the training instance to generate an output. The output can be directly obtained from the one or more machine-learned models or can be a downstream result of a chain of processing operations that includes an output of the one or more machine-learned models.

At 606, example method 600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 608, example method 600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 600 can include implementing a number of generalization techniques (e.g., weight decays, dropouts, etc.) to improve the generalization capability of the models being trained.

In some implementations, example method 600 can be implemented for training a machine-learned model from an initialized state to a fully trained state (e.g., when the model exhibits a desired performance profile, such as based on accuracy, precision, recall, etc.).

In some implementations, example method 600 can be implemented for particular stages of a training procedure. For instance, in some implementations, example method 600 can be implemented for pre-training a machine-learned model. Pre-training can include, for instance, large-scale training over potentially noisy data to achieve a broad base of performance levels across a variety of tasks/data types. In some implementations, example method 600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, arXiv:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), chemical or biochemical data, image data, audio data, audiovisual data, haptic data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and astronomical data, sensor data and chemical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16x16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66–71 (October 31–November 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 8 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter’s toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

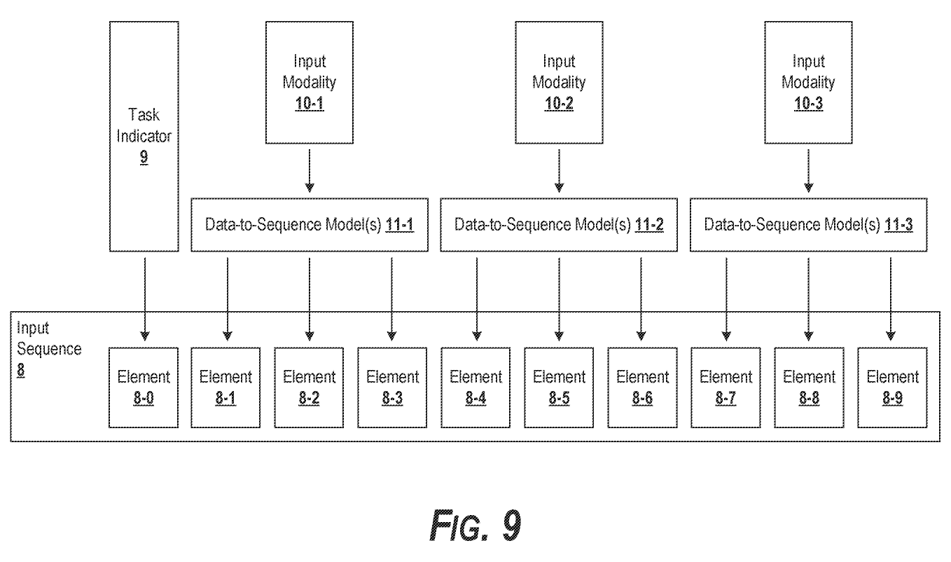

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

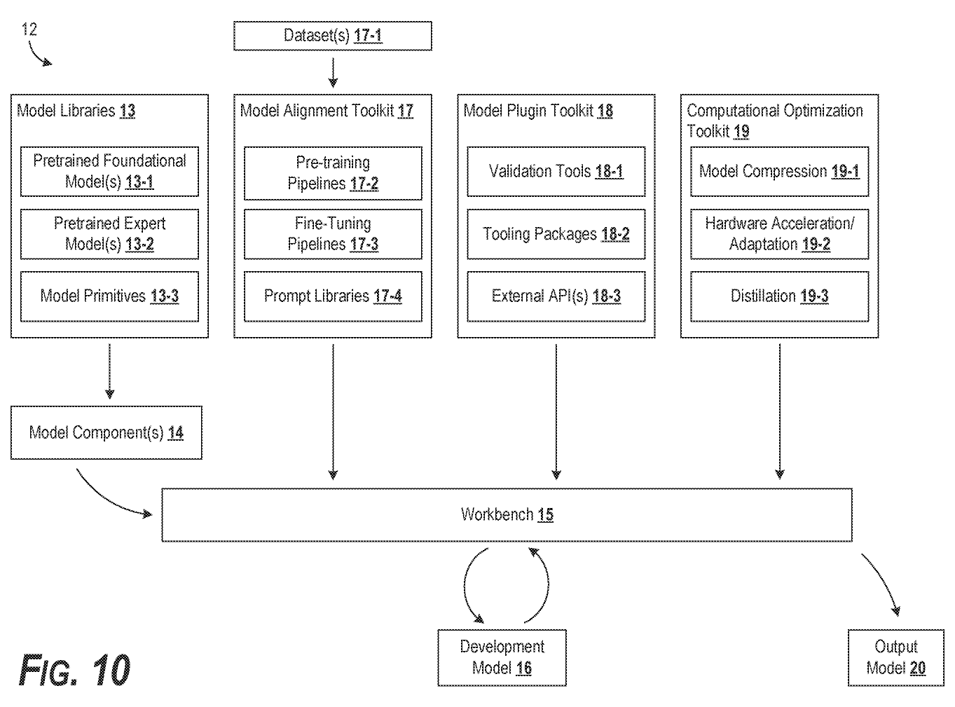

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 600 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

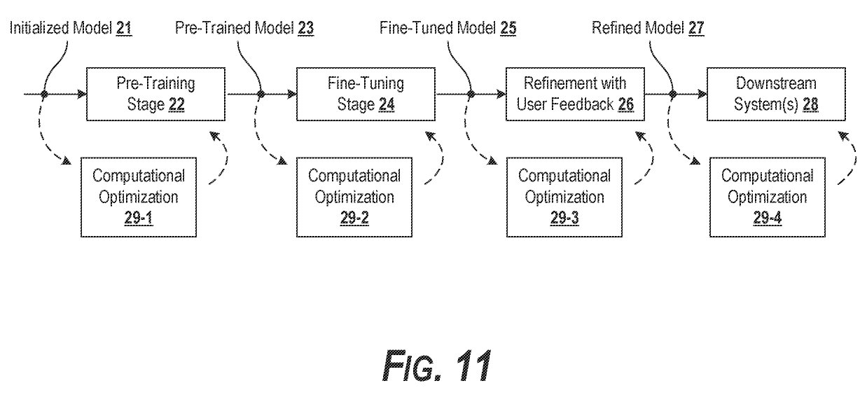

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

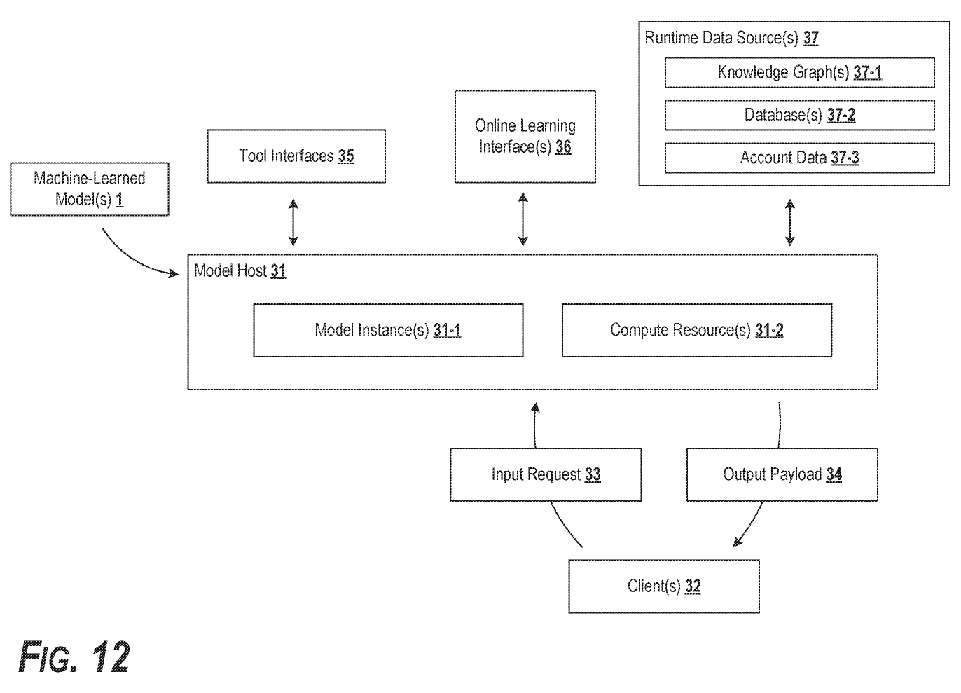

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

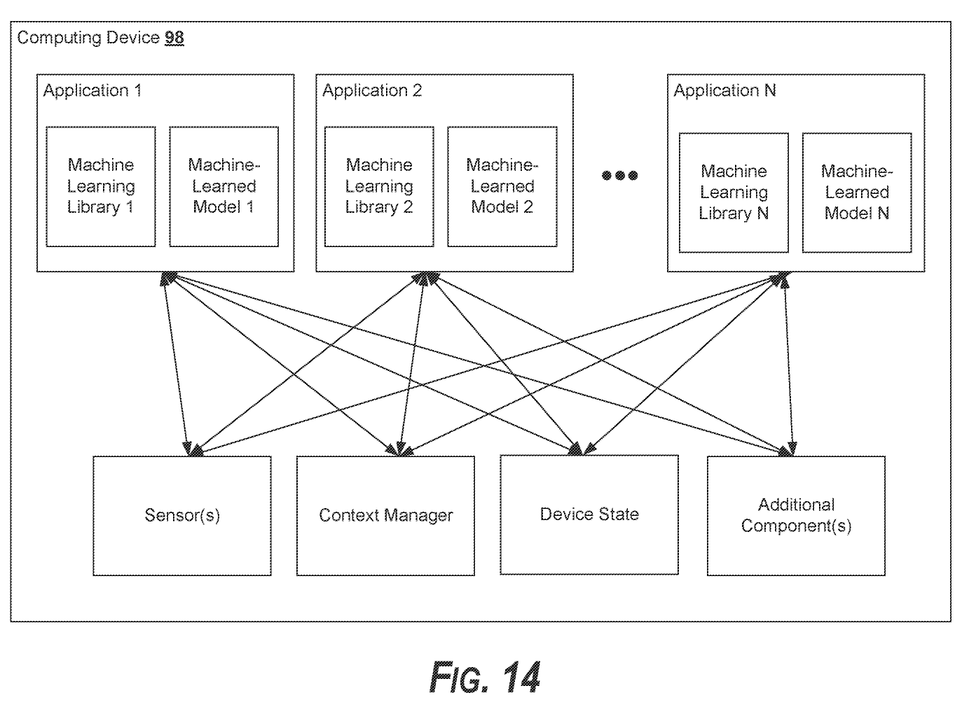

FIG. 14 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

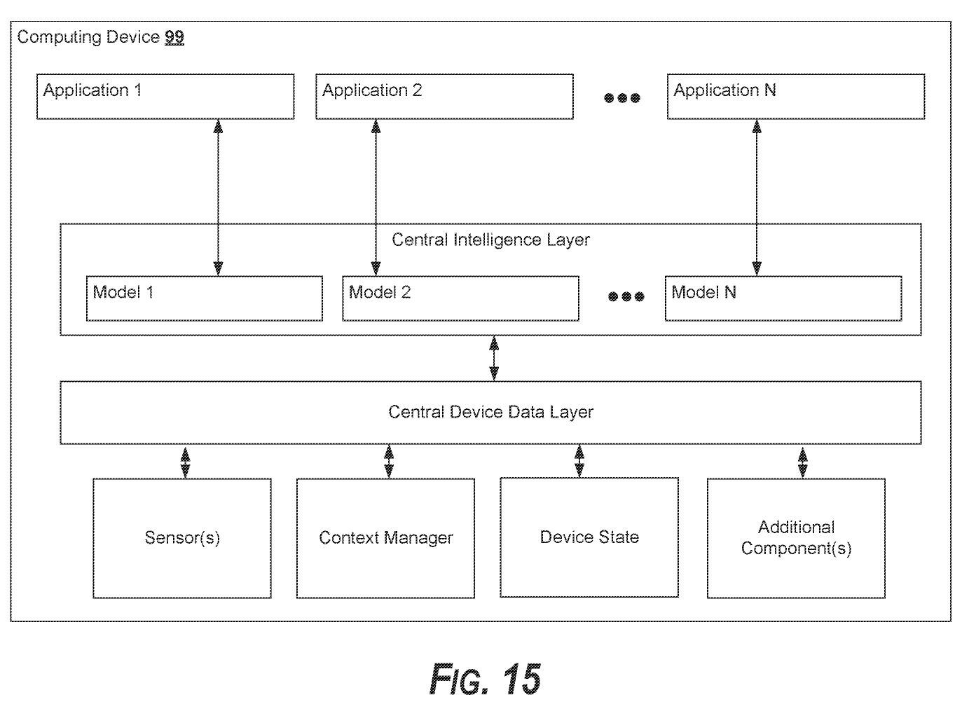

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A method comprising:
providing, by a computing system comprising one or more computing devices to a first machine-learned model, first documentation data indicative of an application programming interface (API);
receiving, by the computing system from the first machine-learned model, one or more inference outputs comprising data indicative of one or more instructions associated with the API, wherein the one or more inference outputs are generated based at least in part on the first documentation data; and
generating, by the computing system based at least in part on the one or more instructions associated with the API, second documentation data indicative of the API.

2. The method of claim 1, wherein generating the second documentation data based at least in part on the one or more instructions associated with the API comprises:
providing, by the computing system to the API, the one or more instructions;
receiving, by the computing system from the API, result data indicative of one or more results of executing the one or more instructions; and
generating, by the computing system based at least in part on the result data, the second documentation data.

3. The method of claim 1, wherein generating the second documentation data comprises:
providing, to the first machine-learned model or a second machine-learned model, at least one of:
the first documentation data;
the one or more instructions associated with the API; and
data generated based on the one or more instructions associated with the API.

4. The method of claim 1, wherein the first machine-learned model is a machine-learned agent configured to use one or more tools, and further comprising:
providing, by the computing system to the machine-learned agent, one or more queries configured to cause the machine-learned agent to call the API, wherein the one or more instructions are received responsive to the one or more queries;
providing, by the computing system to the API, the one or more instructions;
receiving, by the computing system from the API, result data indicative of one or more results of executing the one or more instructions;
providing, by the computing system to the machine-learned agent, the result data; and
receiving, by the computing system from the machine-learned agent, a first output generated based at least in part on the result data and the one or more queries;
wherein generating the second documentation data comprises generating based at least in part on one or more of the first output and the result data.

5. The method of claim 4, further comprising:
providing, by the computing system to a second machine-learned model configured to evaluate computer code data, the one or more queries and the one or more instructions associated with the API; and
receiving, by the computing system from the second machine-learned model, a second output evaluating the one or more instructions in relation to the one or more queries;
wherein generating the second documentation data comprises providing, to a third machine-learned model, the second output evaluating the one or more instructions in relation to the one or more queries.

6. The method of claim 5, wherein the second machine-learned model comprises a model that was trained using error data comprising erroneous instructions associated with the API.

7. The method of claim 4, further comprising:
providing, by the computing system to a second machine-learned model, the one or more queries and the result data; and
receiving, by the computing system from the second machine-learned model, a second output evaluating the result data in relation to the one or more queries;
wherein generating the second documentation data comprises providing, to a third machine-learned model, the second output evaluating the result data in relation to the one or more queries.

8. The method of claim 4, further comprising:
providing, by the computing system to a second machine-learned model, the one or more queries and the first output; and
receiving, by the computing system from the second machine-learned model, a second output evaluating the first output in relation to the one or more queries;
wherein generating the second documentation data comprises providing, to a third machine-learned model, the second output evaluating the first output in relation to the one or more queries.

9. The method of claim 4, further comprising:
generating, by a second machine-learned model based at least in part on the first documentation data, the one or more queries.

10. The method of claim 1, wherein the first machine-learned model is configured to:
identify one or more parts of the API for which the first documentation data is incomplete; and
generate the one or more API instructions based on the one or more parts.

11. The method of claim 10, wherein the first machine-learned model has been trained using one or more training examples comprising:
incomplete documentation data that was generated by removing a portion of third documentation data; and
a first query associated with the removed portion of the third documentation data.

12. The method of claim 10, further comprising:
generating, by the first machine-learned model, test data comprising:
at least one instruction associated with the API; and
a test description output describing information to be learned from a result of the at least one instruction.

13. The method of claim 1, wherein generating the second documentation data comprises:
generating, by the computing system, a plurality of candidate documentation examples; and
determining, by the computing system based at least in part on the plurality of candidate documentation examples, the second documentation data.

14. The method of claim 13, wherein determining the second documentation data based at least in part on the plurality of candidate documentation examples comprises selecting one or more candidate documentation examples based at least in part on a metric of verbosity.

15. The method of claim 13, wherein determining the second documentation data based at least in part on the plurality of candidate documentation examples comprises:
providing, to the first machine-learned model or a second machine-learned model, third documentation data based on a first candidate documentation example of the plurality of candidate documentation examples;
receiving, from the first machine-learned model or the second machine-learned model, at least one API instruction; and
determining, based at least in part on the at least one API instruction, whether to include the first candidate documentation example in the second documentation data.

16. The method of claim 1, further comprising:
comparing, by the computing system, one or more first method signatures of the first documentation data to one or more second method signatures of a candidate documentation example to the first documentation data; and
performing at least one of:
rejecting, by the computing system responsive to determining that the one or more second method signatures are materially different from the one or more first method signatures, the candidate documentation example; and
including, by the computing system responsive to determining that the one or more second method signatures are not materially different from the one or more first method signatures, the candidate documentation example in the second documentation data.

17. The method of claim 1, wherein the API is a first API, and further comprising:
providing, by the computing system to the first machine-learned model, third documentation data indicative of a second API; and
receiving, by the computing system from the first machine-learned model, one or more inference outputs comprising data indicative of one or more instructions associated with the second API, wherein the one or more inference outputs are generated based at least in part on the third documentation data;
wherein generating the second documentation data comprises generating combined documentation data based at least in part on the first documentation data and the third documentation data.

18. The method of claim 1, further comprising:
generating, based at least in part on the second documentation data, data indicative of a suggested modification to the API.

19. The method of claim 1, further comprising:
providing, by the computing system to the first machine-learned model or a second machine-learned model, the second documentation data and data indicative of a user query;
generating, by the first machine-learned model or the second machine-learned model, based at least in part on the second documentation data, one or more instructions associated with the API; and
providing, by the computing system to the API, the one or more instructions to cause the API to perform one or more operations.

20. The method of claim 19, wherein the API is an API for controlling a smart home device, and wherein the one or more operations comprise one or more of:
activating or deactivating the smart home device;
opening or closing the smart home device or a component thereof;
setting a temperature value associated with the smart home device; and
selecting an input to the smart home device.

21. The method of claim 19, wherein:
the second documentation data comprises first requirement data indicative of one or more requirements for validly calling the API;
the first documentation data lacks the first requirement data; and
the one or more instructions comply with the one or more requirements.

22. The method of claim 21, wherein the one or more requirements comprise one or more of:
a minimum or maximum numerical value for one or more parameters of the one or more instructions;
a set of valid values for one or more parameters of the one or more instructions; and
a set of device states from which the one or more instructions can be executed.

23. The method of claim 21, wherein the one or more requirements comprise at least one requirement wherein a violation of the at least one requirement would cause the API to encounter an exception or error.

24. A computing system comprising one or more processors and one or more non-transitory computer-readable media storing instructions that are executable by one or more processors to cause the computing system to perform operations, the operations comprising:
providing, to a first machine-learned model, first documentation data indicative of an application programming interface (API);
receiving, from the first machine-learned model, one or more inference outputs comprising data indicative of one or more instructions associated with the API, wherein the one or more inference outputs are generated based at least in part on the first documentation data; and
generating, based at least in part on the one or more instructions associated with the API, second documentation data indicative of the API.

25. One or more non-transitory computer-readable media storing instructions that are executable by one or more processors to cause a computing system to perform operations, the operations comprising:
providing, to a first machine-learned model, first documentation data indicative of an application programming interface (API);
receiving, from the first machine-learned model, one or more inference outputs comprising data indicative of one or more instructions associated with the API, wherein the one or more inference outputs are generated based at least in part on the first documentation data; and
generating, based at least in part on the one or more instructions associated with the API, second documentation data indicative of the API.
